(19) United States
(12) Patent Application Publication
(10) Pub. No.: US 2013/0254714 A1
(43) Pub. Date: Sep. 26, 2013

(54) METHOD AND APPARATUS FOR PROVIDING FLOATING USER INTERFACE

(71) Applicant: SAMSUNG ELECTRONICS CO., LTD., Gyeonggi-do (KR)

(72) Inventors: Hang-Sik SHIN, Gyeonggi-do (KR); Sung-Joo AHN, Seoul (KR); Jung-Hoon PARK, Seoul (KR); Hyun-Guk YOO, Gyeonggi-do (KR)

(73) Assignee: Samsung Electronics Co., Ltd., Gyeonggi-do (KR)

(21) Appl. No.: 13/849,226

(22) Filed: Mar. 22, 2013

(30) Foreign Application Priority Data
Mar. 23, 2012 (KR) 10-2012-0030197

(51) Int. Cl. G06F 3/0482

(52) U.S. Cl. CPC G06F 3/0482
USPC 715/810

(57) ABSTRACT

An apparatus and method of providing a floating user interface is provided. A floating user interface including menus for executable terminal functions is activated and a terminal function is executed through the floating user interface, thus enabling a user to conveniently perform terminal functions through the floating user interface under any environment of the terminal.

### PRIORITY

This application claims priority under 35 U.S.C. §119(a) to a Korean Patent Application filed in the Korean Intellectual Property Office on Mar. 23, 2012, and assigned Serial No. 10-2012-0030197, the entire disclosure of which is incorporated herein by reference.

### BACKGROUND OF THE INVENTION

1. Field of the Invention

The present invention relates generally to a method and apparatus for providing a user interface, and more particularly, to a method and apparatus for providing a floating user interface having terminal function menus for performing a terminal function.

2. Description of the Related Art

In general, a user interface displayed on a terminal consists of a background screen image and a menu configuration image having menu items in a text format or in an icon format. When a menu item is selected by a user with a mouse or his/her finger, the terminal performs the corresponding terminal function.

For example, if the user wishes to perform a screen rotation function of the terminal while playing a certain image, the terminal operates as follows:

A selection of a menu list provided in an image reproducing application is input through the user input means, and the terminal displays the menu list on the screen. If a terminal function menu for screen rotation is selected from among the menu list, the terminal rotates and displays the current screen.

The terminal also performs functions corresponding to respective button inputs by pressing corresponding buttons placed on the exterior of the terminal, such as a power button, volume control buttons, a camera button, and the like if they exist.

As such, conventional terminals perform terminal functions in response to menu inputs through the user interface with the menu configuration image, or button inputs.

In this case, the user may be inconvenienced from having to make many inputs to display a menu list or a menu screen to perform a desired terminal function.

In this respect, disabled users in particular may have difficulty making repetitive selections in the user interface or pressing functional buttons on the exterior of the terminal.

### SUMMARY OF THE INVENTION

The present invention has been made to address at least the above problems and disadvantages and to provide at least the advantages described below. Accordingly, the present invention provides a method and apparatus for providing a floating user interface to perform terminal functions by making a simple input.

In accordance with an aspect of the present invention, an apparatus for providing a floating user interface is provided, the apparatus including a user input means; a display unit for displaying a floating user interface including menus for terminal functions; and a controller for displaying the floating user interface upon request by the user input means; and performing a terminal function that corresponds to a menu included in the floating user interface when there is a request to execute the menu.

In accordance with another aspect of the present invention, a method of providing a floating user interface is provided, the method including displaying a floating user interface including menus for terminal functions if a request for displaying the floating user interface is made by a user input means; and performing a terminal function that corresponds to a menu included in the floating user interface which is requested to be executed.

### BRIEF DESCRIPTION OF THE DRAWINGS

The above and other aspects features and advantages of the present invention will become more apparent by describing in detail embodiments thereof with reference to the attached drawings in which:

FIG. 1 is a block diagram of an apparatus for providing a floating user interface, according to an embodiment of the present invention;

FIG. 2 is a flowchart illustrating a method of providing an integrated terminal function interface to enable an apparatus for providing a floating user interface to perform terminal functions, according to an embodiment of the present invention;

FIGS. 3A and 3B illustrate a process of activating and moving a floating user interface, according to an embodiment of the present invention;

FIG. 4 illustrates a process of deactivating an activated floating user interface, according to an embodiment of the present invention;

FIGS. 5A and 5B illustrate a process of activating and moving a floating user interface using a mouse, according to an embodiment of the present invention;

FIGS. 6A and 6B illustrate a process of changing a position of an identifier to execute a floating user interface, according to an embodiment of the present invention;

FIGS. 7A, 7B and 8 illustrate a process of changing a position of an identifier to activate a floating user interface using a mouse, according to an embodiment of the present invention;

FIGS. 9A and 9B illustrate a process of shifting and displaying a plurality of menu pages through a floating terminal function interface, according to an embodiment of the present invention;

FIGS. 10A and 10B illustrate a process of shifting and displaying a plurality of menu pages through a floating user interface using a mouse, according to an embodiment of the present invention;

FIGS. 11A, 11B, 12A, 12B, 13A, 1313, 14A, 14B, 15A, 15B, 16A and 16B illustrate processes of setting up menus to perform terminal functions through a floating user interface, according to embodiments of the present invention;

FIGS. 17A to 17D illustrate a process of setting up a user action to record user inputs in response to gesture inputs through a floating user interface, according to an embodiment of the present invention;

FIGS. 18A to 18D illustrate a process of setting up a user action to record user inputs in response to voice inputs through a floating user interface, according to an embodiment of the present invention;

FIGS. 19A and 19B illustrate a process of executing a user action set up in response to a gesture input, according to an embodiment of the present invention;

FIGS. 20A and 20B illustrate a process of executing a user action set up in response to a voice input, according to an embodiment of the present invention;

FIGS. 21A and 21B illustrate a process of displaying a list of user actions set up through a floating user interface, according to an embodiment of the present invention;

FIG. 22 illustrates a process of deleting a list of user actions set up through a floating user interface, according to an embodiment of the present invention;

FIG. 23 illustrates a process of navigating and moving a list of user actions set up through a floating user interface, according to an embodiment of the present invention;

FIGS. 24A and 24B illustrate a process of executing a reboot menu through a floating user interface, according to an embodiment of the present invention;

FIGS. 25A to 25C illustrate a process of executing an adjust ringtone volume menu through a floating user interface, according to an embodiment of the present invention;

FIGS. 26A to 26C illustrate a process of executing an adjust multimedia volume menu through a floating user interface, according to an embodiment of the present invention;

FIGS. 27A to 27C illustrate a process of executing a zoom-in or zoom-out menu through a floating user interface, according to an embodiment of the present invention;

FIGS. 28A to 28C illustrate a process of executing a zoom-in or zoom-out menu through a floating user interface using a mouse, according to an embodiment of the present invention;

FIGS. 29A to 29C illustrate a process of executing a page shift menu through a floating user interface using a mouse, according to an embodiment of the present invention;

FIGS. 30A and 30B illustrate a process of moving pages based on positions of a page shift icon in executing a page shift menu using a mouse, according to an embodiment of the present invention;

FIGS. 31A and 31B illustrate a process of executing a capture screen menu through a floating user interface, according to an embodiment of the present invention;

FIGS. 32A and 32B illustrate a process of executing a rotate screen menu through a floating user interface, according to an embodiment of the present invention;

FIG. 33 illustrates a process of executing an external function menu through a floating user interface, according to an embodiment of the present invention; and

FIG. 34 illustrates a process of running a plurality of floating user interfaces, according to an embodiment of the present invention.

### DETAILED DESCRIPTION OF EMBODIMENTS OF THE PRESENT INVENTION

Reference will now be made in detail to embodiments, examples of which are illustrated in the accompanying drawings, wherein like reference numerals refer to the like elements throughout. Detailed description of well-known functionalities and configurations will be omitted to avoid unnecessarily obscuring the present invention.

In embodiments of the present invention, a floating user interface including menus for executable terminal functions is activated and a terminal function is executed through the floating user interface, thus enabling a user to conveniently execute functions of the terminal through the floating user interface under any environment of the terminal.

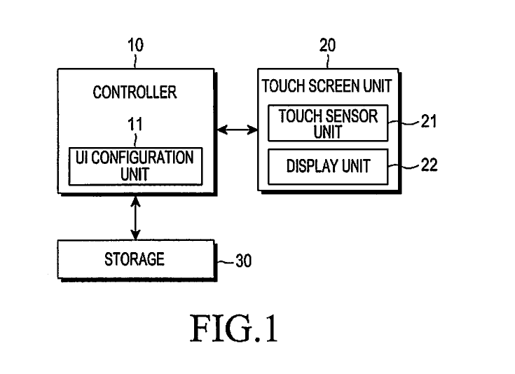

FIG. 1 is a block diagram of an apparatus for providing a user interface, according to an embodiment of the present invention.

The apparatus includes a controller 10 that contains a user interface (UI) configuration unit 11, a touch screen unit 20 that contains a touch sensor unit 21 and a display unit 22, and a storage 30.

The controller 10 controls general operations of the apparatus, and in particular controls the UI configuration unit 11 to generate the floating user interface for performing terminal functions upon request. The floating user interface herein includes menus for terminal functions, the menus including menus for exterior buttons placed on the exterior of the terminal, menus for mechanical functional buttons, favorite menus to be set up based on user preferences, etc.

The controller 10 displays the floating user interface at a predetermined position of the display unit 22. The floating user interface is displayed at a predetermined position on the top layer of the display unit 22.

The controller 10 performs a terminal function that corresponds to a terminal function menu selected when the terminal function menu is selected in the floating user interface.

The UI configuration unit 11 of the controller 10 generates the floating user interface including terminal function menus and displays the floating user interface on the top layer of the display unit 22.

The touch screen unit 20 containing the touch sensor unit 21 and the display unit 22 detects a user's touch, creates the detection signal and sends the detection signal to the controller 10. The touch sensor unit 21 may be configured with touch-detection sensors based on e.g., a capacitive overlay scheme, resistive overlay scheme, a infrared beam scheme or the like, or pressure sensors; however, is the touch-detection sensors are not limited thereto but may be any types of sensors able to detect contact or pressure of an object.

The display unit 22 may be formed of a Liquid Crystal Display (LCD) and visually provide menus of the portable terminal, input data, functional setting information and other different information to the user. The display unit 22 may consist of various devices other than the LCD device. The display unit 22 outputs the portable terminal's boot screen, standby screen, display screen, call screen, and other application-run screens. In particular, the display unit 22 displays the floating user interface on its top layer. Specifically, the display unit 22 displays a background user interface on the bottom layer of the display unit 22, displays a plurality of menu items on the background user interface, and then displays a floating user interface in a partial area of the top layer of the display unit 22. The background user interface refers to a background image of the display unit 22 to be displayed on the bottom layer. There may be a layer on which at least one menu item is displayed or a layer on which a screen for a running application is displayed between the top and bottom layers.

The floating user interface is always displayed on the top layer no matter what screen, such as the standby screen, the application-run screen, and the like is currently displayed, enabling the user to freely perform terminal functions using the floating user interface. In embodiments of the present invention, the user input means corresponds to the user's touch input, but any other configurations may be used to communicate with an external interface device with which to execute the floating user interface. In other words, the user input means may include a touch-input means, such as the user's finger, a stylus pen, or the like and a pointing input means, such as a typical mouse, a blowup mouse, an eye mouse that uses the pupil of the eye, or the like.

The storage 30 for storing data to be generally used in the apparatus stores the floating user interface generated by the user interface configuration unit 11 and data related to terminal function menus contained in the floating user interface.

As such, the user may conveniently use menus in the floating user interface under any terminal environment by executing the floating user interface through a touch-input or user input means, such as a mouse.

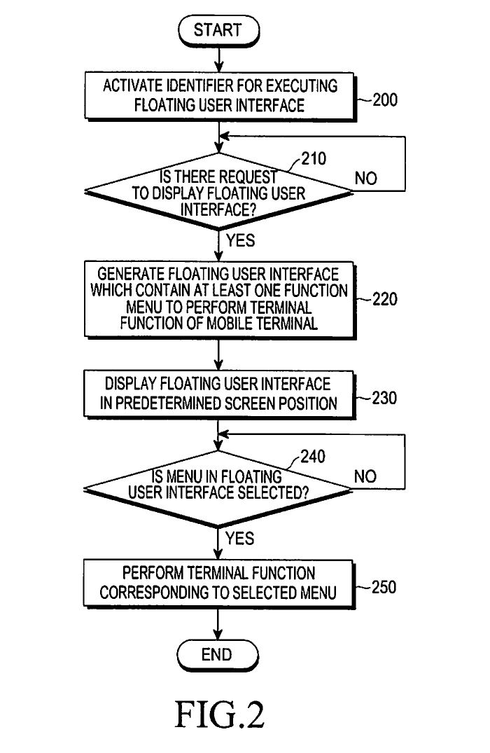

FIG. 2 is a flowchart illustrating a method of providing the floating user interface to enable the apparatus for providing a user interface to perform terminal functions, according to an embodiment of the present invention.

At step 200, the controller 10 activates an identifier to execute the floating user interface that includes terminal function menus. The identifier is activated and displayed at a predetermined position of the display unit 22.

At step 210, the controller 10 determines whether there is a request to display the floating user interface, and if there is the request proceeds to step 220 or, otherwise, repeats step 210. The request to display the floating user interface refers to an operation, such as a touch on the identifier with the user input means or a click on the identifier using a mouse pointer. Such an operation may also correspond to entering or selecting the request. For example, the controller 10 determines that the request is made if the identifier displayed at the predetermined position is selected.

At step 220, the controller 10 generates the floating user interface that includes at least one terminal function menu to perform terminal functions. At step 230, the controller 10 displays the generated floating user interface at a predetermined position of the display unit 22. Specifically, the controller 10 displays the floating user interface at a predetermined position on the top layer of the display unit 22. Alternatively, the floating user interface may be displayed in an area of a predetermined size to contain the at least one terminal function menu.

The controller determines whether a selection of any of the at least one terminal function menu is made in the floating user interface, at step 240, and proceeds to step 250 if the selection is made, or otherwise, repeats step 240. At step 250, the controller 10 performs a terminal function corresponding to the selected terminal function menu. For example, if the selected terminal function menu is a reboot menu to reboot the terminal, the controller 10 turns off the terminal and back on.

As such, the user may conveniently use menus in the floating user interface under any terminal environment by executing the floating user interface through a touch-input or user input means, such as a mouse.

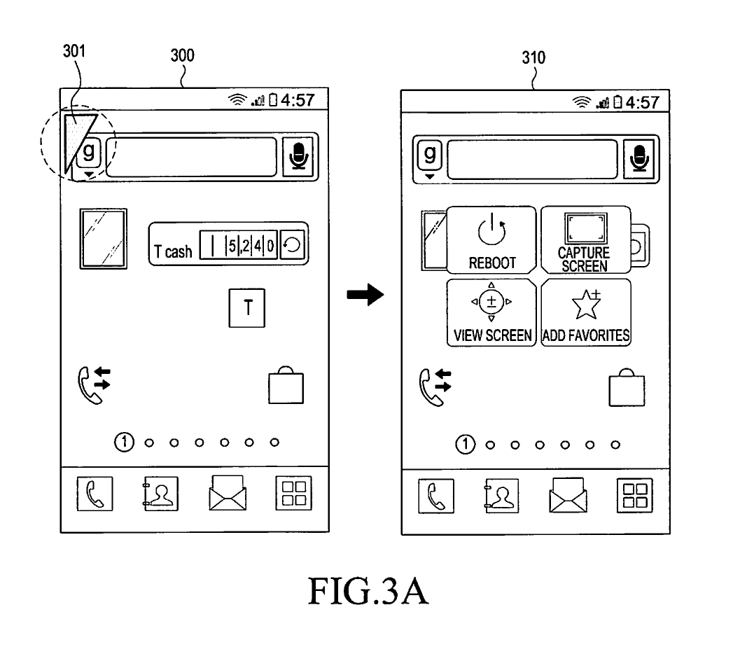

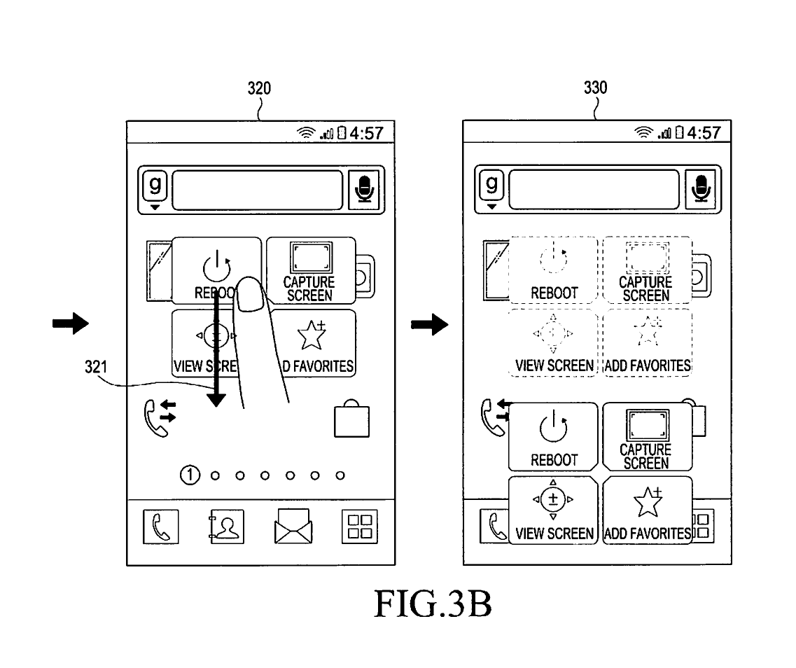

FIGS. 3A and 3B illustrate a process of activating and moving the floating user interface, according to an embodiment of the present invention. In this embodiment, the terminal is assumed to be in the standby mode displaying a standby screen.

In a screen 300 of FIG. 3A, the controller 10 activates and displays an identifier 301 for executing the floating user interface at a predetermined position in advance. The identifier 301 may be displayed on the top layer of the display unit 22 and have various shapes. Since the identifier 301 is displayed to be overlapped with the background image or any menu item(s), which is displayed on the bottom layer, the identifier 301 may be blurred for the background image or the menu item to be seen.

If a touch is made on the identifier 301, the controller 10 generates and displays the floating user interface that includes terminal function menus in a screen 310. The floating user interface includes run menus for terminal functions, such as reboot, capture screen, zoom-in and zoom-out screen, add favorites, and the like.

If detecting a touch-and-drag input to move the floating user interface in a screen 320 of FIG. 3B, the controller 10 determines a dragging direction 321 of the touch-and-drag input and moves the floating user interface in the dragging direction. The controller 10 determines the touch-and-drag input detected within where the floating user interface is displayed as an input to move the floating user interface.

The controller 10 then moves and displays the floating user interface in the dragging direction, as shown in a screen 330. The top layer on which the floating user interface is displayed is processed transparently so that the background image or the menu item may be displayed in an area other than where the floating user interface is displayed.

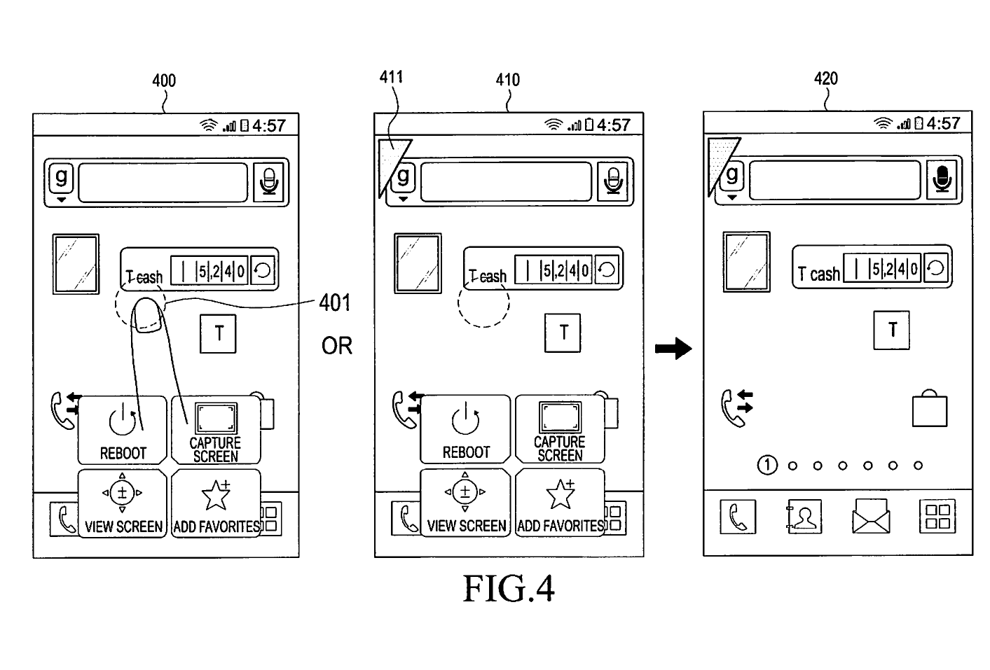

FIG. 4 illustrates a process of deactivating an activated floating user interface, according to an embodiment of the present invention.

Upon detection of a touch input 401 within the area other than where the floating user interface is displayed in a screen 400, the controller 10 stops displaying the floating user interface as shown in a screen 420.

Also, when a touch input is detected on an identifier 411 while the floating user interface is displayed as shown in a screen 410, the controller 10 stops displaying the floating user interface as shown in a screen 420.

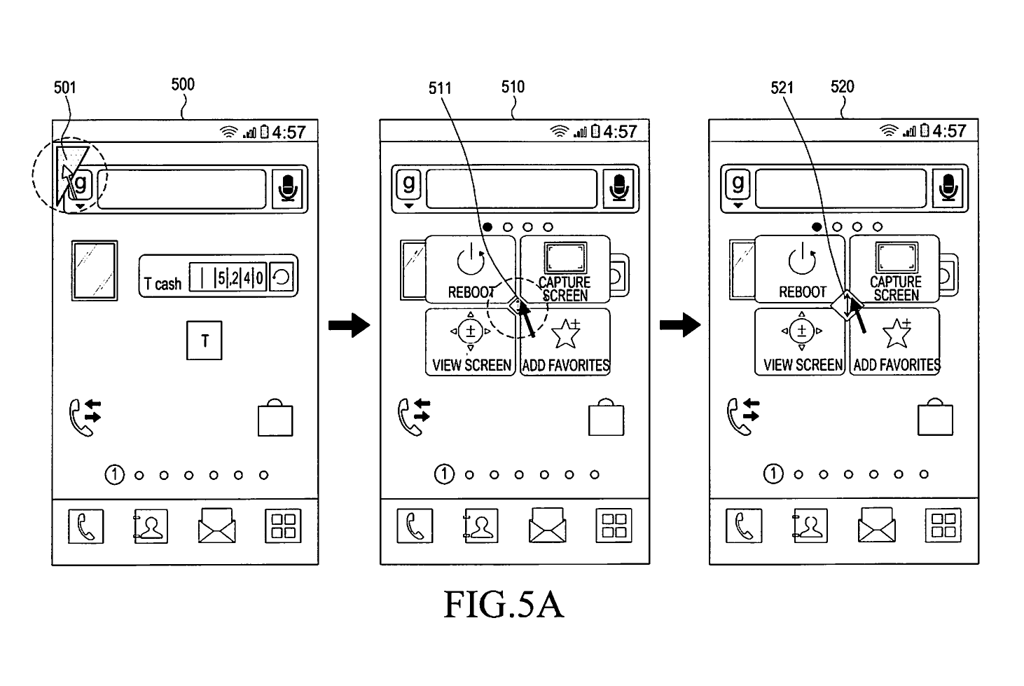

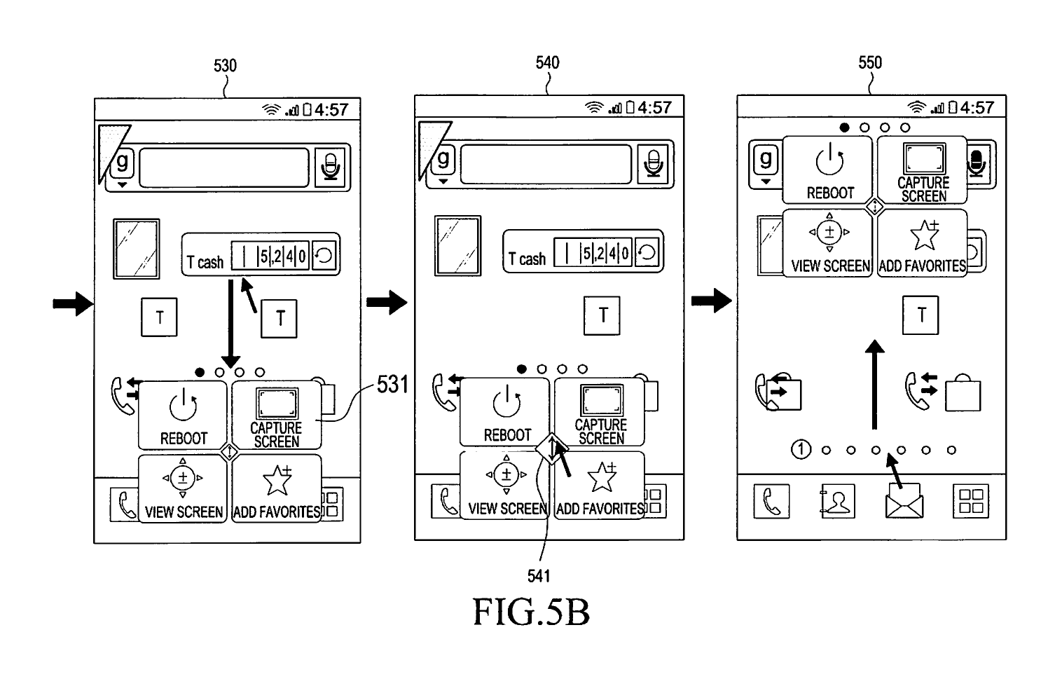

FIGS. 5A and 5B illustrate a process of activating and moving the floating user interface using a mouse, according to an embodiment of the present invention.

When a pointer input of the mouse is detected at the position of an identifier 501 for executing the floating user interface as shown in a screen 500 of FIG. 5A, the controller 10 displays the floating user interface at a predetermined position as shown in a screen 510. The pointer input of the mouse refers to an input made by a user clicking on a mouse button. When the pointer input is detected on an arrow-shaped image displayed at a position 511, the controller 10 displays an expanded diamond-shaped icon image 521 in a predetermined size at where the pointer input is detected. The icon image 521 may also be displayed as an extended animation in another embodiment.

After that, when a pointer input on the icon image 521 is detected, the controller 10 moves the floating user interface to an area other than where the floating user interface has been displayed, as shown in a screen 530 of FIG. 5B. For example, if the floating user interface is positioned on the upper screen part of the display unit 22, the controller 10 moves the floating user interface down to the lower screen part of the display unit 22.

If the floating user interface is positioned on the lower screen part of the display unit 22 as shown in a screen 540 and a pointer input is detected on an icon image 541, the controller 10 moves the floating user interface up to the upper screen part of the display unit 22 as shown in a screen 550.

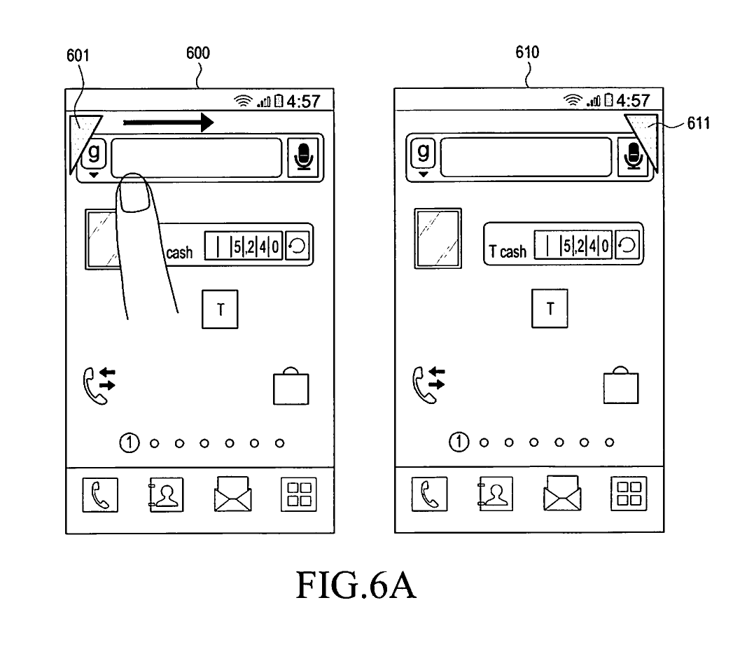

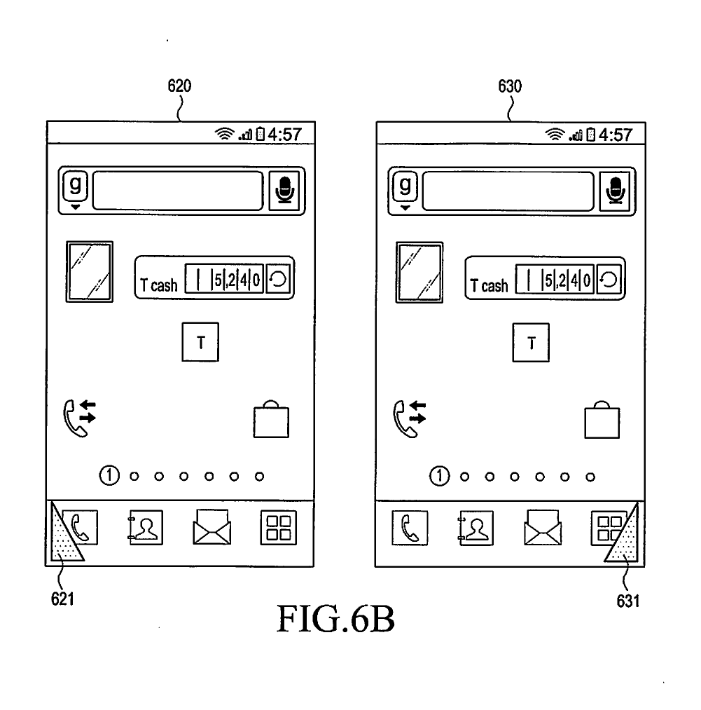

FIGS. 6A and 6B illustrate a process of changing a position of an identifier for running the floating user interface, according to an embodiment of the present invention.

Upon detection of a touch-and-drag input at a position of an identifier 601 for running the floating user interface in a screen 600 of FIG. 6A, the controller 10 determines a dragging direction of the touch-and-drag input and moves the identifier 601 in the dragging direction. For example, when the identifier 601 is positioned at the top-left screen part of the display unit 22 and a touch-and-drag input in the left-to-right direction is detected, the controller 10 determines that the dragging direction is toward the right and moves and displays the identifier 601 to the top-right screen part 611 of the display unit 22, as shown in a screen 610.

When an identifier 621 is positioned at the bottom-left screen part of the display unit 621 as shown in a screen 620 of FIG. 6B and a touch-and-drag input in the left-to-right direction is detected, the controller 10 determines that the dragging direction is toward the right and moves and displays the identifier 621 to the bottom-right screen part 631 of the display unit 22 in screen 630.

In another example where the identifier 601 is positioned at the top-left screen part, as shown in the screen 600 of FIG. 6A, if a touch-and-drag input in the top-to-bottom direction is detected, the controller 10 determines that the dragging direction is toward the bottom and moves the identifier 601 to the bottom-left screen part, as shown in a screen 620 of FIG. 6B. On the contrary, where the identifier 621 is positioned at the bottom-left screen part, as shown in the screen 620 of FIG. 6B, if a touch-and-drag input in the bottom-to-top direction is detected, the controller 10 determines that the dragging direction is toward the top and moves the identifier 621 to the top-left screen part, as shown in a screen 600.

In yet another example where an identifier 611 is positioned at the top-right screen part, as shown in the screen 610 of FIG. 6A, if a touch-and-drag input in the top-to-bottom direction is detected, the controller 10 determines that the dragging direction is toward the bottom and moves the identifier 611 to the bottom-right screen part, as shown in the screen 630 of FIG. 6B. On the contrary, where an identifier 631 is positioned at the bottom-right screen part, as shown in the screen 630, if a touch-and-drag input in the bottom-to-top direction is detected, the controller 10 determines that the dragging direction is toward the top and moves the identifier 631 to the top-right screen part, as shown in the screen 610 of FIG. 6A.

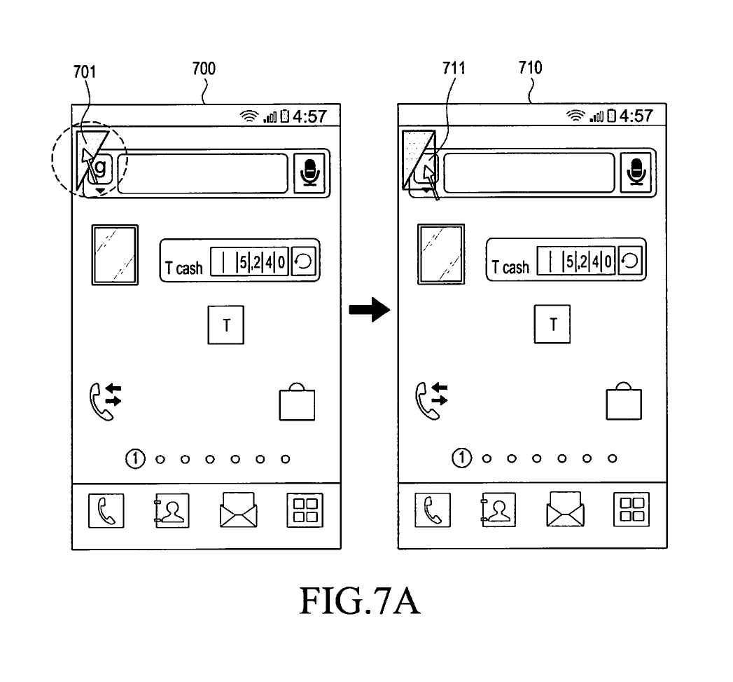

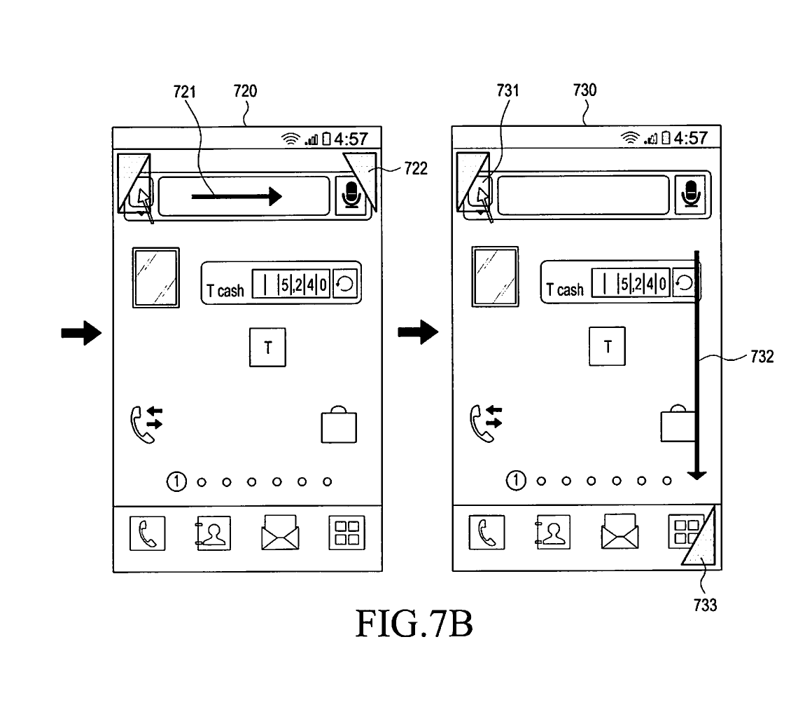

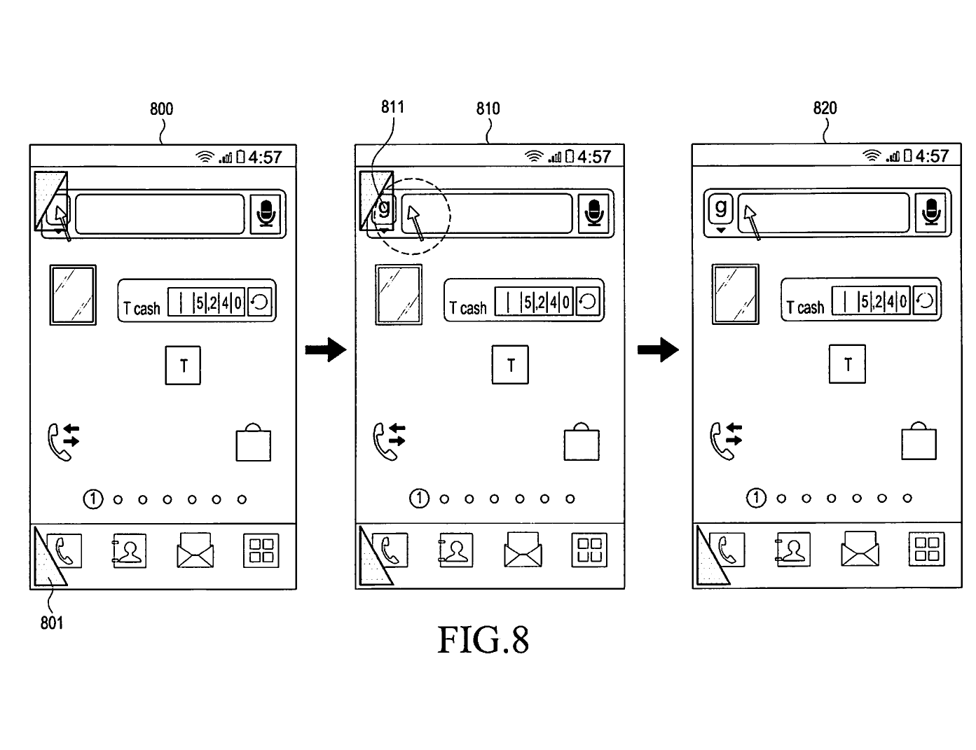

FIGS. 7A, 7B and 8 illustrate a process of changing a position of an identifier for running the floating user interface using a mouse, according to an embodiment of the present invention.

If a mouse pointer has been detected at a position of an identifier 701 in a screen 700 of FIG. 7A for a predetermined time, the controller 10 displays a position moving icon 711 for moving the identifier 701 at the same area where the identifier 701 is displayed as shown in a screen 710.

Then, upon detection of a mouse pointer input at the position of the position moving icon 711, the controller 10 moves the identifier from the top-left screen part as shown in the screen 701 to the top-right screen part as indicated by a right directional arrow 721. After that, if there is another mouse pointer input 731 at the position of the position moving icon 711, the controller 10 moves an identifier 722 to a bottom-right position 733 as indicated by a downward arrow 732.

If the identifier is moved to where there is a reference numeral 801 in a screen 800 of FIG. 8 and there is one more mouse pointer input, the controller 10 moves and displays the identifier back to the original position 811.

After that, as shown in a screen 810, if any mouse pointer input has been detected for a predetermined time at the position of the position moving icon 811, the controller 10 stops displaying the position moving icon as shown in a screen 820 and settles the identifier 801 at the bottom-left screen part for display.

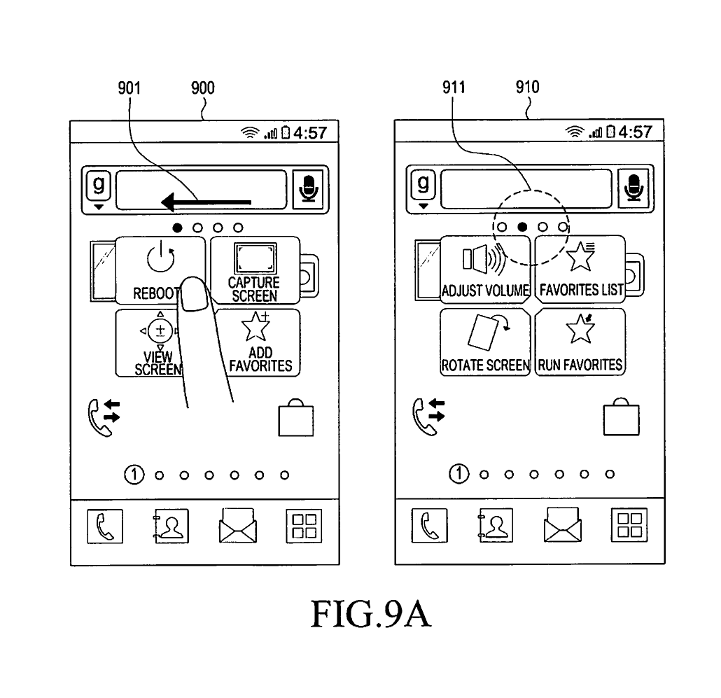

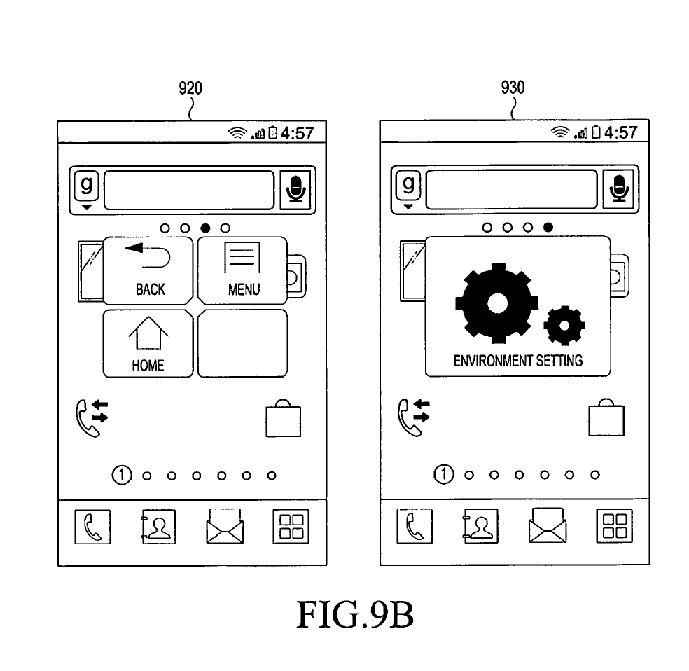

FIGS. 9A and 9B illustrate a process of shifting and displaying a plurality of menu pages through the floating user interface, according to an embodiment of the present invention.

Upon detection of a touch-and-drag input within an area where the floating user interface is displayed as shown in a screen 900 of FIG. 9A, the controller 10 determines a dragging direction of the touch-and-drag input, moves out a menu page that contains currently displayed terminal function menus and displays the next menu page containing some other terminal function menus. Those terminal function menus contained in menu pages may be arranged according to a predetermined arrangement rule or in an arrangement order defined by the user. For example, if there is a request to run the floating user interface, the controller 10 displays as many terminal function menus as determined in advance in an arrangement order of terminal function menus. In this case, four terminal function menus may be displayed as in the screen 900. However, more or a fewer number of terminal function menus may also be displayed in other embodiments.

In a screen 910 of FIG. 9A, the controller 10 may indicate where a currently displayed menu page is among the entire menu pages by displaying a menu shift navigating icon 911 above the currently displayed menu page. Furthermore, as shown in a screen 920 of FIG. 9B, upon detection of a touch-and-drag input to shift pages, the controller 10 displays the next menu page containing some terminal function menus.

As shown in a screen 930, the controller 10 may display an environment setting menu in the last menu page. Arrangement order of the terminal function menus in these menu pages may be set up by default or by the user. In addition, the dragging direction detected based on the touch-and-drag input may not be limited to the left direction as illustrated in the foregoing embodiments, but may be any direction in which menu pages are shifted.

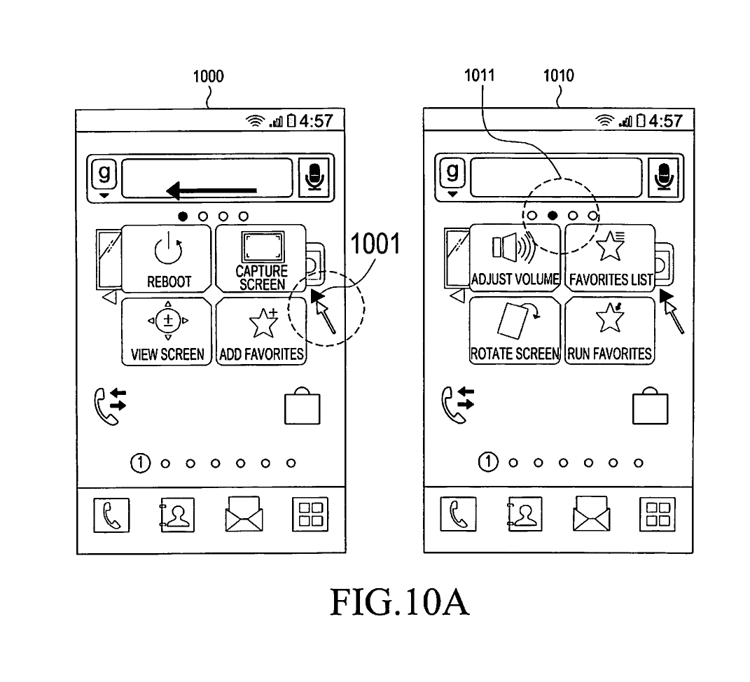

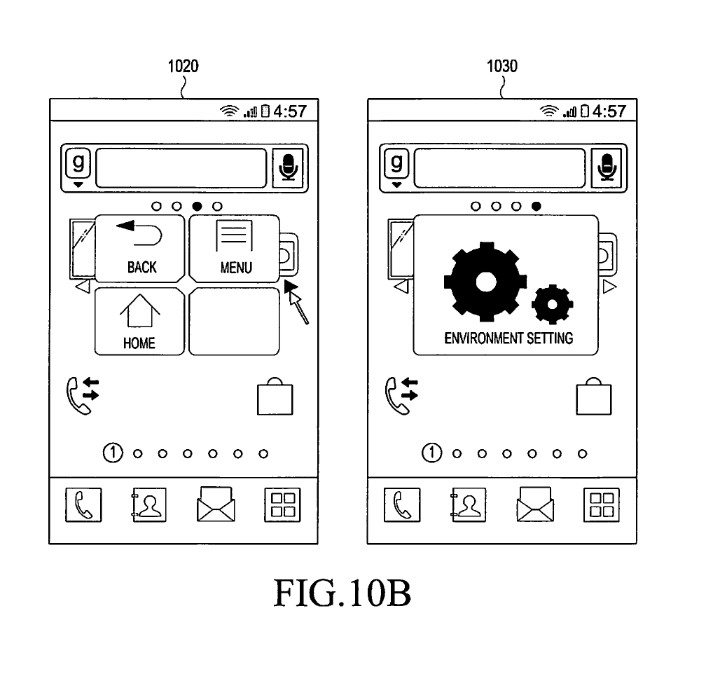

FIGS. 10A and 10B illustrate a process of shifting and displaying a plurality of menu pages through the floating user interface using a mouse, according to an embodiment of the present invention.

As shown in a screen 1000 of FIG. 10A, the controller 10 displays an arrow icon 1001 for shifting menu pages, and moves and displays the next menu page arranged in the arrow direction if there is a mouse pointer input on the arrow icon 1001. The arrow icon 1001 may be placed on the left or right of the menu page pointing the vertical center, as shown in the screen 1000.

In a screen 1010, the controller 10 may indicate where the currently displayed menu page is among the entire menu pages by displaying a menu shift navigating icon 1011 above the currently displayed menu page. Furthermore, as shown in a screen 1020 of FIG. 10B, upon detection of a touch-and-drag input to shift pages, the controller 10 displays the next menu page containing some terminal function menus.

As shown in a screen 1030, the controller 10 may display an environment setting menu in the last menu page.

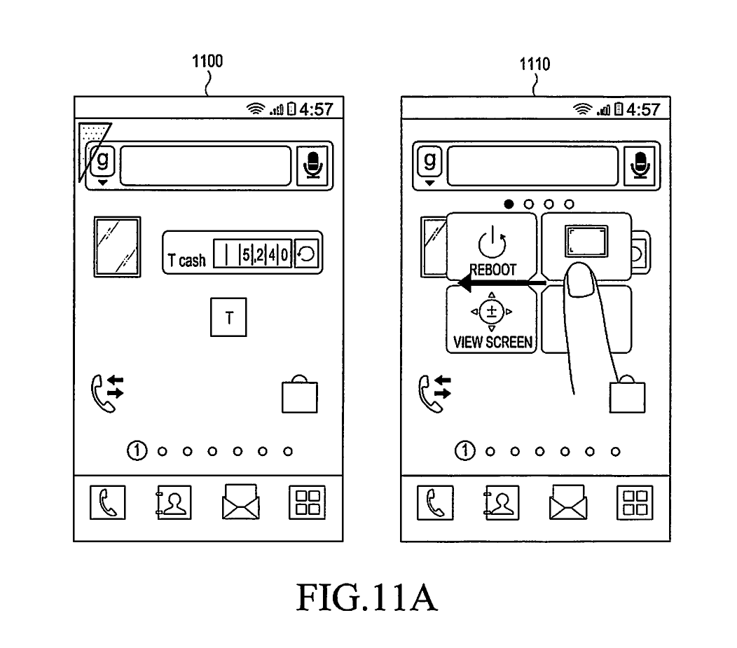

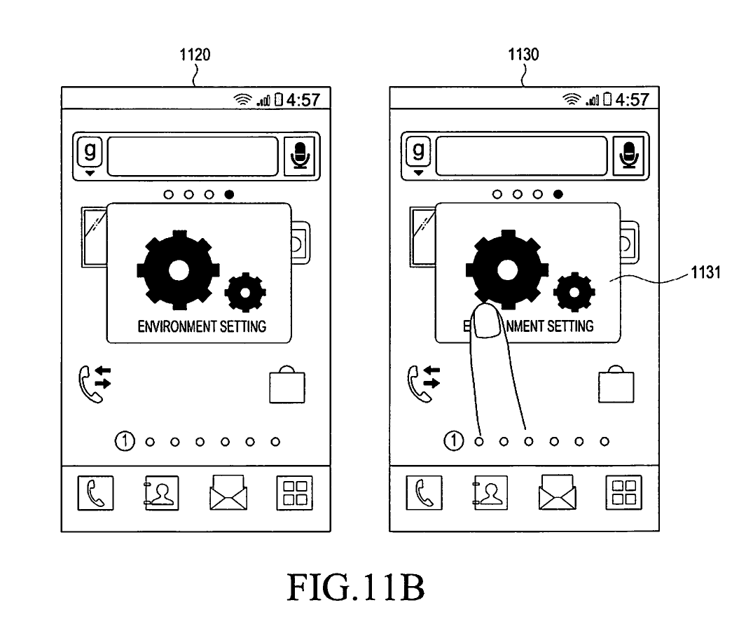

FIGS. 11A and 11B to 16A and 16B illustrate processes of setting up menus to perform terminal functions through the floating user interface, according to embodiments of the present invention.

FIGS. 11A and 11B illustrate a process of displaying the environment setting menu for setting up menus selected by a user input means.

If an identifier to execute the floating user interface is selected as shown in a screen 1100 of FIG. 11A, the controller 10 displays a menu page that contains some terminal function menus as shown in a screen 1110. After that, upon detection of a touch-and-drag input to request for page shifting to select the environment setting menu, the controller 10 determines a drag direction based on the touch-and-drag input, shifts menu pages in the dragging direction, and displays the environment setting menu as shown in a screen 1120 of FIG. 11B. Upon detection of a touch input on environment setting menu 1131 to execute a terminal function for the environment setting menu in a screen 1130, the controller 10 executes the terminal function for the environment setting menu.

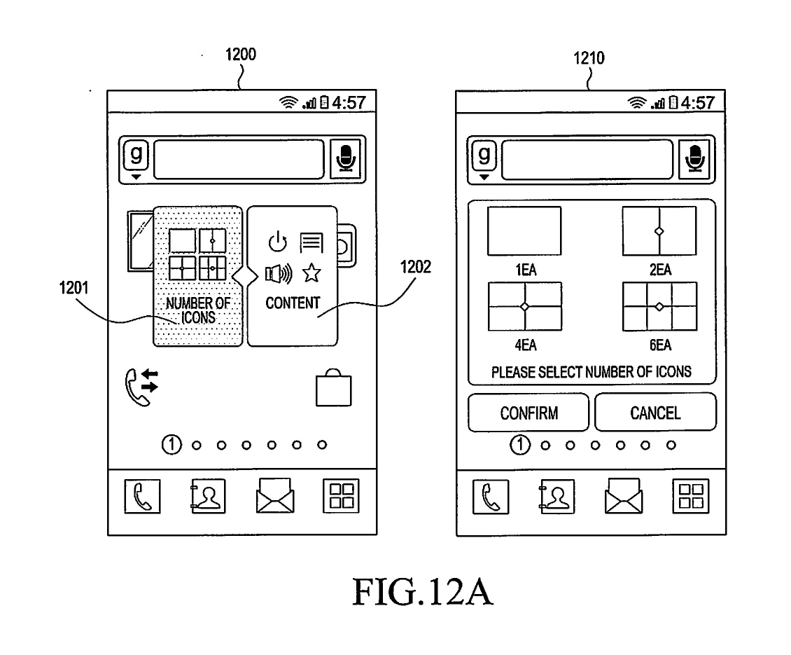

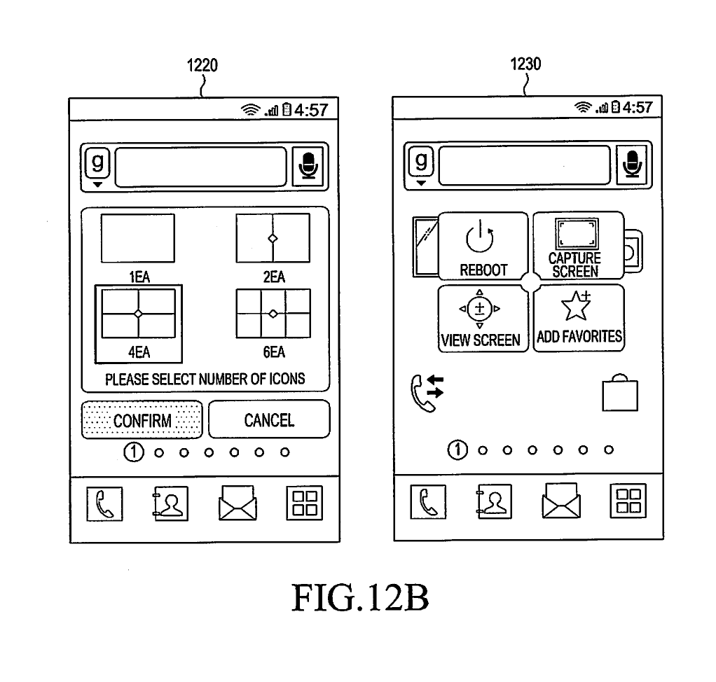

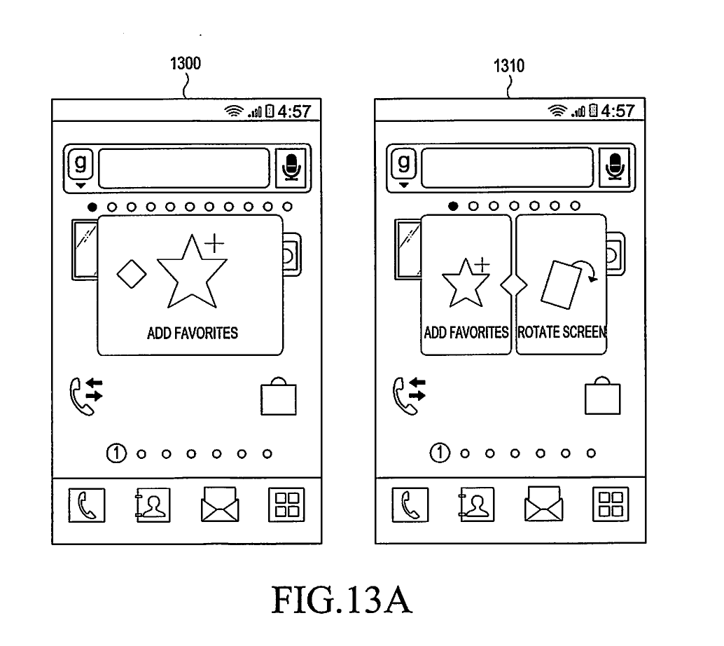

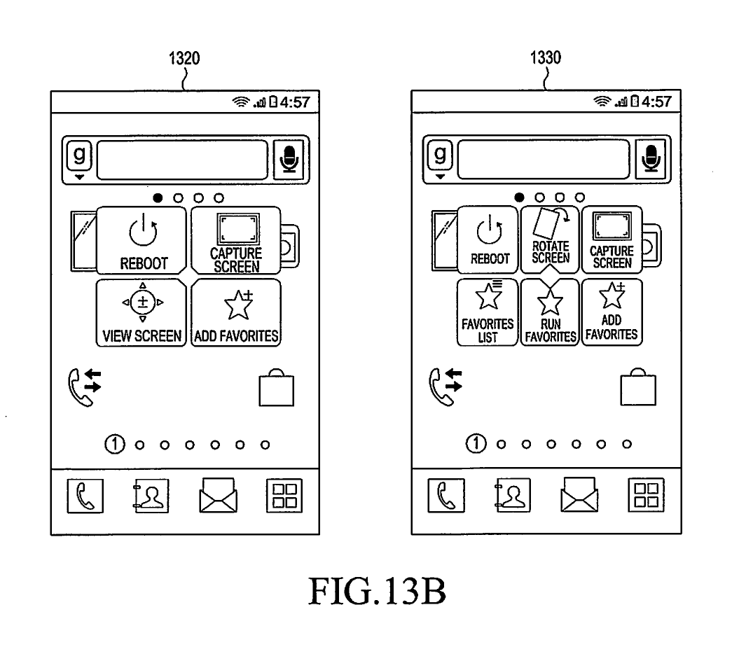

FIGS. 12A, 12B, 13A and 13B illustrate processes of setting the number of menus to be contained in a menu page in the floating user interface, according to embodiments of the present invention.

As shown in a screen 1200 of FIG. 12A, the controller 10 displays an environment setting menu item for executing the terminal function for the environment setting menu. The environment setting menu item includes a menu item titled ‘Number of Icons’ 1201 to set the number of menu items to be displayed in a menu page and a menu item titled ‘Content’ 1202 to set types of menu items to be displayed in the menu page.

When the user selects the menu item ‘Number of Icons’ 1201 with a user input means, the controller 10 displays a screen to select the number of menu items to be displayed in a single menu page, as shown in a screen 1210. In this embodiment, one, two, four, and six menu items may be selected. However, the number of menu items is not limited thereto, and more or a fewer number of menu items may be selected in other embodiments.

When the number of menu items is selected by the user with the user input means as in a screen 1220 of FIG. 12B, the controller 10 displays a menu page configured with the selected number of menu items as in a screen 1230. For example, if the user selects ‘4’ to be the number of menu items of a single menu page, the controller 10 displays 4 menu items in the menu page as in a screen 1230.

In FIG. 13A, the controller 10 displays one menu item in a menu page as in a screen 1300 if the number of menu items is selected to be ‘1’, and displays two menu items in a menu page as in a screen 1310 if the number of menu items is selected to be ‘2’. Also, the controller 10 displays four menu items in a menu page as in a screen 1320 if the number of menu items is selected to be ‘4’, and displays six menu items in a menu page as in a screen 1330 if the number of menu items is selected to be ‘6’, as shown in FIG. 13B.

In other embodiments of the present invention, not only the number of menu items but also the size of an area where the menu item is displayed may be selected and set.

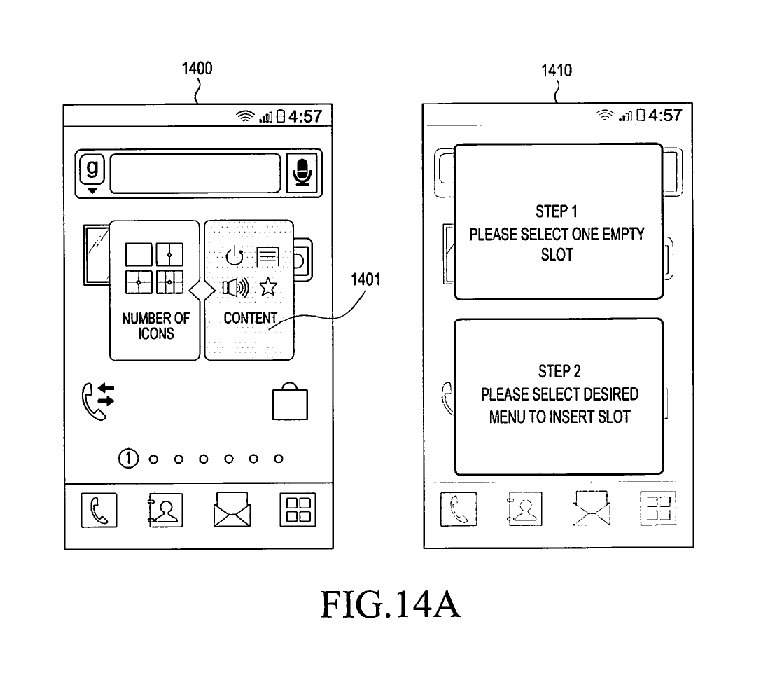

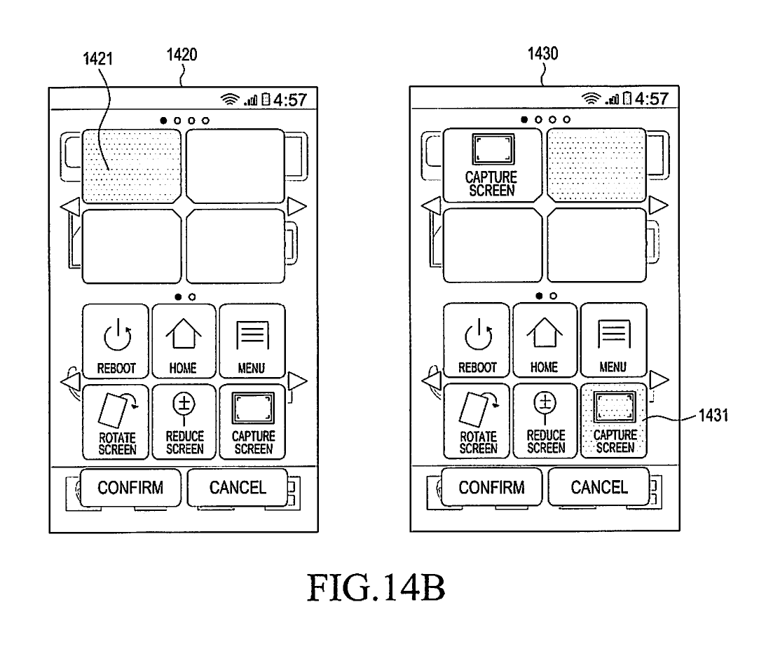

FIGS. 14A and 14B to 16A and 16B illustrate processes of setting types of menu items to be displayed in a menu page, according to embodiments of the present invention.

Upon selection of a menu item titled ‘Content’ 1401 to set types of menu items to be displayed in a menu page with the user input means as shown in screen 1400 of FIG. 14A, the controller 10 may display a guiding phrase to guide the user to set types of menu items as shown in a screen 1410. The controller 10 may also perform a notifying operation for guiding the user, such as displaying guiding phrases or speaking out guiding remarks. Such a notifying operation is optional and may not necessarily be performed.

As shown in a screen 1420 of FIG. 14B, the controller 10 displays selectable menu items with menu selection areas in which to select menu items to be displayed based on the set number of menu items. The menu selection areas are set to be the same as the number of the set menu items. A predetermined number of menu items are displayed in a menu page, and with the page shift, some other menus may be displayed.

After that, if a menu selection area 1421 is selected from among the plurality of menu selection areas and, as in a screen 1430, a first menu item 1431 is selected, the controller 10 displays the first menu item 1431 in the menu selection area 1421 and sets the first menu item 1431 to be displayed in the floating user interface. For example, if the ‘Capture Screen’ menu item is selected with a user input means, the controller 10 displays the ‘Capture Screen’ menu item in the first menu selection area among four menu selection areas.

In the embodiments of the present invention, a menu screen is configured by selecting a plurality of menu selection areas and menu items to be displayed in the menu selection areas. However, in other embodiments, upon detection of a touch-and-drag input on any of the plurality of menu items by the user input means, the controller 10 moves the menu item selected by the touch in the dragging direction based on the touch-and-drag input and displays the menu item in a menu selection area where a drop input is detected among the plurality of menu selection areas.

Furthermore, if any of the plurality of menu items is selected by the user input means, the controller 10 displays the selected menu item in the first one of the plurality of menu selection areas. After that, upon successive selection of menu items with the user input means, the controller 10 may sequentially set up and display the selected menu items in menu selection areas determined in a predetermined order.

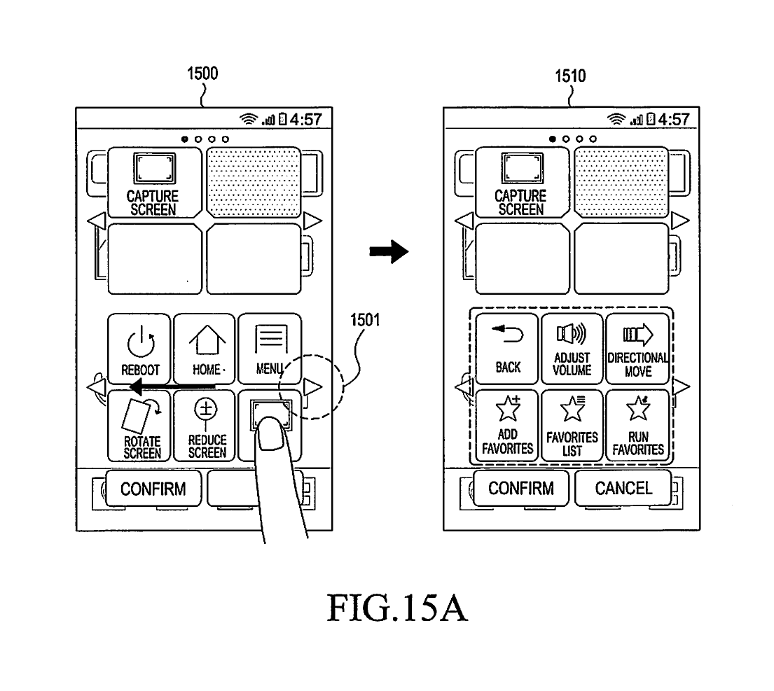

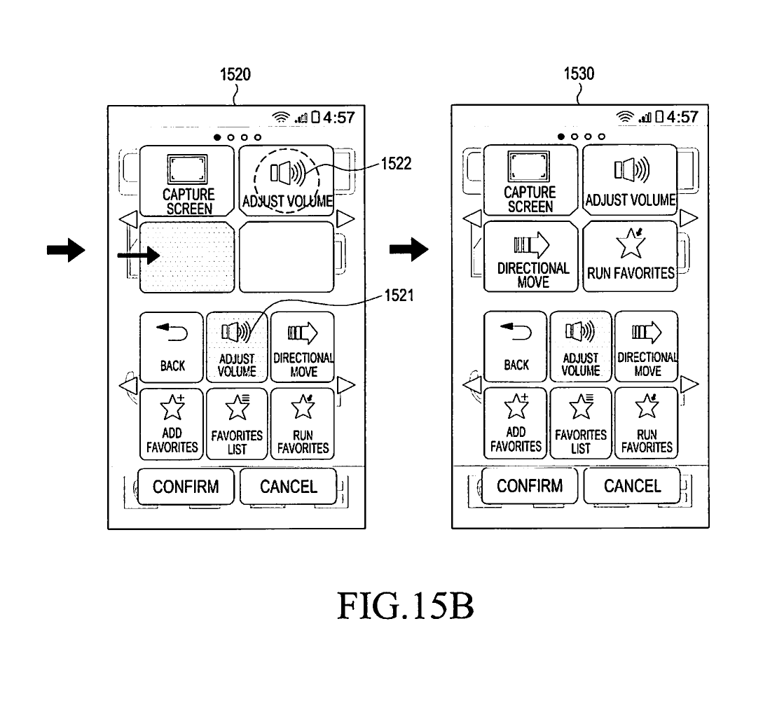

Specifically, upon selection of a page shift icon 1501 for shifting pages as in a screen 1500 of FIG. 15A, the controller 10 shifts menu pages and displays menu items belonging to the next menu page as in a screen 1510.

If a second menu item 1521 is selected by the user input means in a screen 1520 of FIG. 15B, the controller 10 displays the second menu item 1521 in a second menu selection area 1522 and then sets up the second menu item 1521 to be displayed in the floating user interface. For example, if the ‘Adjust Volume’ menu item is selected with the user input means, the controller 10 displays the ‘Adjust Volume’ menu item in the second menu selection area 1522 among four menu selection areas. The second menu selection area 1522 corresponds to the top-right area among the four menu selection menus. With the foregoing process, such menu items selected and displayed in the plurality of menu selection areas as shown in a screen 1530 are set up to be displayed in the floating user interface. In the embodiment, upon selection of a menu item by the user input means, the controller 10 may activate a menu selection area which has not yet been selected in an arrangement order and display the menu item in the menu selection area, as shown in the screen 1520.

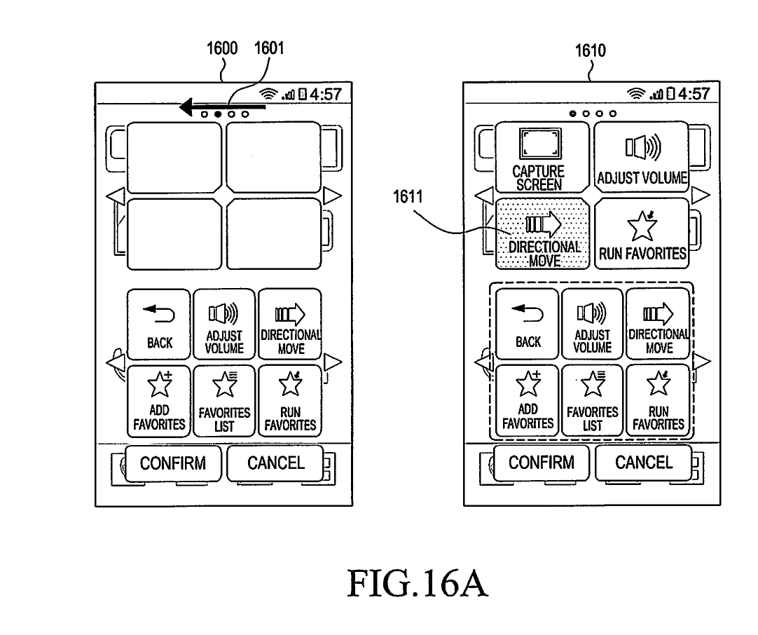

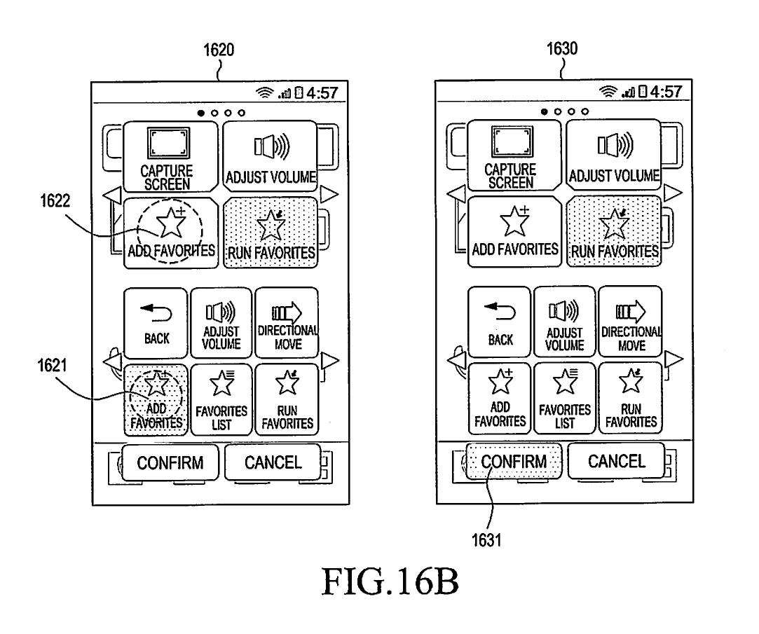

Upon completion of setting up all menu items to be displayed in the first menu page, the controller 10 sets up user-desired menu items in the floating user interface by displaying menu selection areas in which to set up menu items to be displayed in the second menu page, as shown in a screen 1600 of FIG. 16A. For example, upon detection of a touch-and-drag input for page shifting, the controller 10 determines a dragging direction based on the touch-and-drag input and shifts menu pages from the first menu page to the second menu page in the dragging direction as indicated by an arrow 1601 and displays menu selection areas that correspond to the second menu page. In this case, if a directional icon for page shifting is selected, the controller 10 shifts menu pages in the opposite direction of the dragging direction and displays the menu selection areas.

If the user who wants to change a previously setup menu item to any other menu item touches a menu selection area 1611 in which a menu item has been set up as shown in a screen 1610 and touches a menu item 1621 of ‘Add Favorites’ as shown in a screen 1620 of FIG. 16B, the controller 10 changes the previous menu item to the selected menu item in the menu selection area 1622. For example, if the user touches a menu selection area in which the menu item ‘Directional Move’ is displayed and touches the menu item ‘Add Favorites’, the controller 10 replaces the menu item ‘Directional Move’ by the menu item ‘Add Favorites’ in the menu selection area.

After that, if the user selects a ‘Confirm’ button 1631 to complete settings as configured in a screen 1630, the controller 10 stores the current settings and completes the operation of setting up types of the menu items to be displayed in the floating user interface.

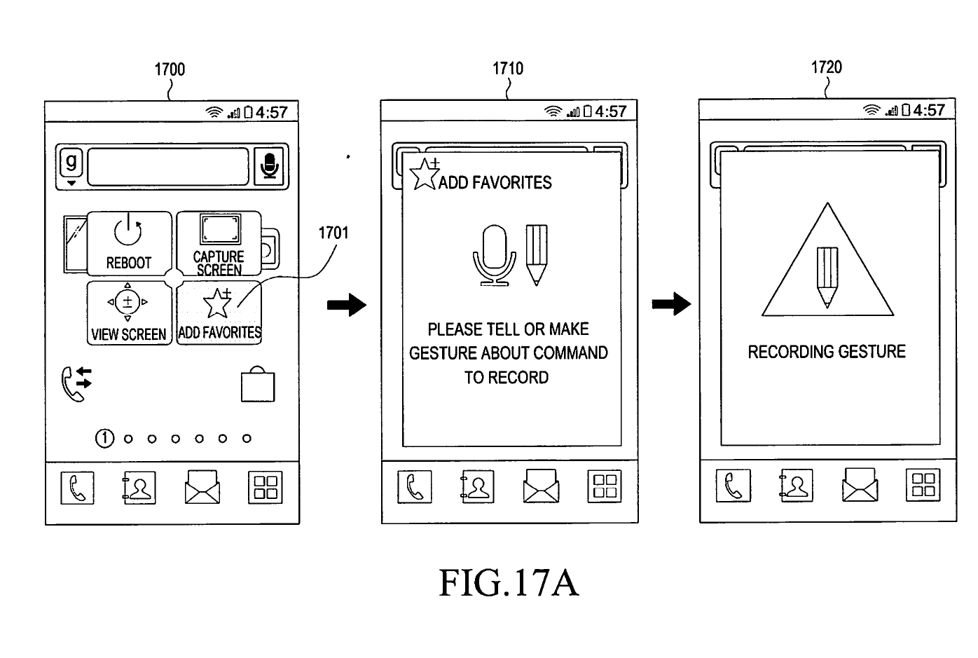

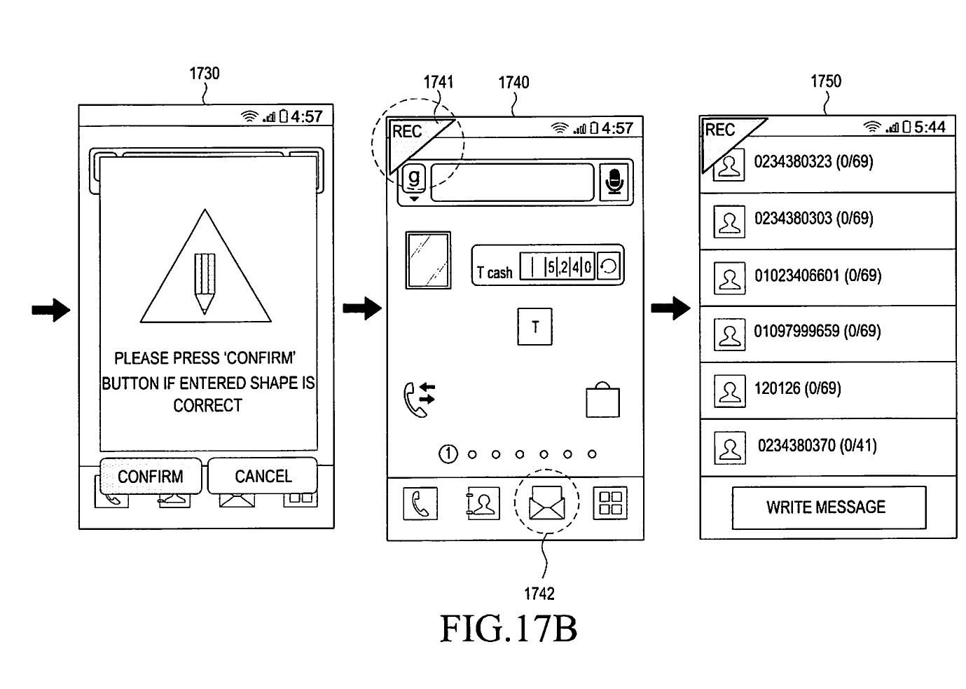

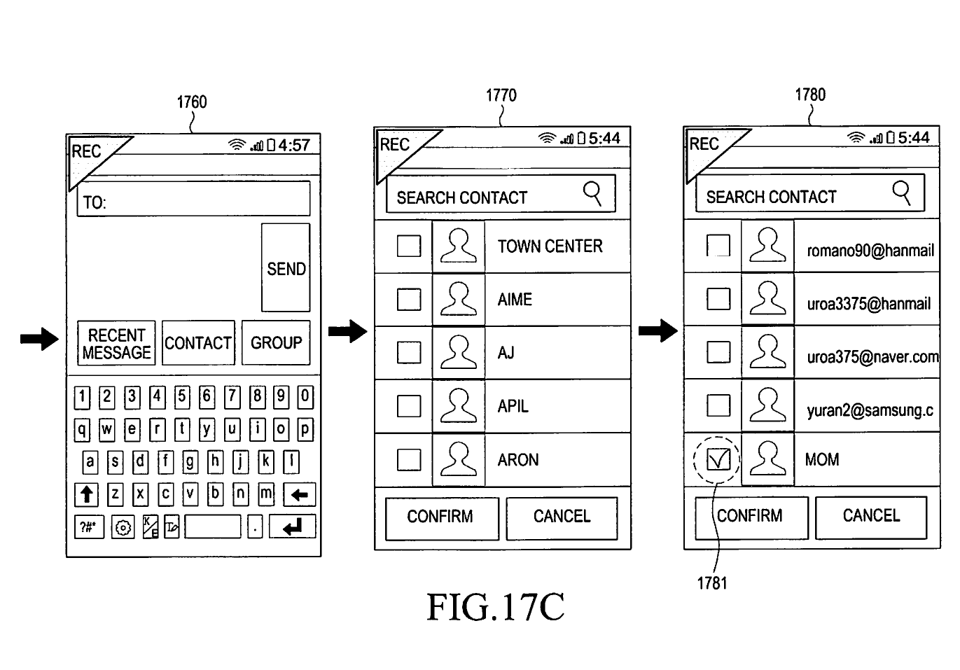

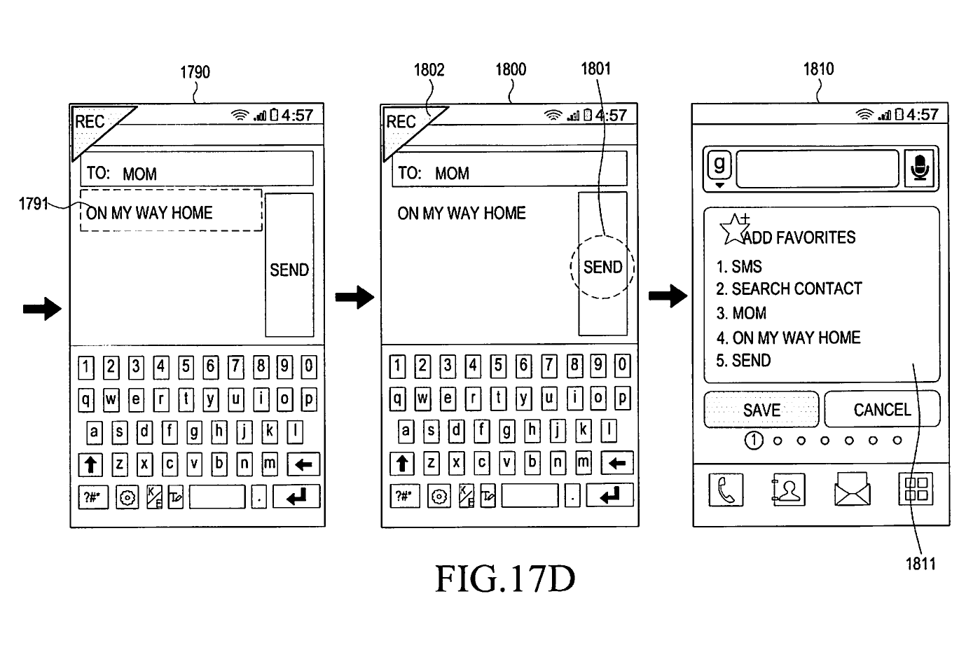

FIGS. 17A to 17D illustrate a process of setting up a user action to record user inputs in response to gesture inputs through the floating user interface, according to an embodiment of the present invention.

Upon selection of the item menu ‘Add Favorites’ 1701, which is a terminal function menu to set up a user action to sequentially write user inputs corresponding to the user-selected terminal function menu in the floating user interface as shown in a screen 1700 of FIG. 17A, the controller 10 displays an input screen to select a type of an operation to implement the user action as shown in a screen 1710. The type of the operation to implement the user action includes a gesture that represents the user's writing input or a voice that represents the user's voice.

If the user's gesture input is detected, the controller 10 displays a guiding screen to indicate that the gesture is being recorded as shown in a screen 1720 and displays a guiding message to confirm whether the input shape is correct as shown in a screen 1730 of FIG. 17B. In the embodiment of the present invention, the writing shape according to a touch input may be determined and displayed as a gesture input.

Then, if the ‘Confirm’ button is selected, the controller 10 displays a screen to write user inputs as shown in a screen 1740. Specifically, the controller 10 displays a recording identifier ‘REC’ 1741 to start recording user inputs, and starts recording a user input if the recording identifier 1741 is selected by a user input means.

If a message sending menu 1742 to send messages is selected by the user input means as shown in a screen 1740, the controller 10 displays a screen of a list of transmitted or received messages corresponding to their contacts as shown in a screen 1750.

After that, if a ‘Message Writing’ function is selected, the controller 10 displays a screen to write a message as shown in a screen 1760 of FIG. 17C. The screen to write a message includes a recipient area into which to enter a recipient, a message area into which to enter a message, a keypad area, a send button to send the message, a recent message button to show a list of recent messages, a contact button to show a list of contacts, a group button to send group messages, and the like.

If the contact button is selected by the user input means as shown in a screen 1760, the controller 10 displays a screen containing the list of contacts stored in the storage 30 as shown in a screen 1770.

If the user selects a contact 1781 to send a message in the screen 1780, the controller 10 displays the selected contact in the recipient area as shown in a screen 1790 of FIG. 17D. Then, if the user enters a phrase, e.g., ‘on my way home’ using the keypad area, the controller 10 displays an entered phrase 1791, e.g., ‘on my way home’ in the message area.

When the user selects the send button indicated by a reference numeral 1801 in a screen 1800, the controller 10 transmits a message containing the entered phrase to the selected contact.

After that, if the recording identifier indicated by a reference numeral 1802 is selected again by the user input means, the controller 10 stops recording the user input and displays a user input list 1811 that enumerates user inputs that have been recorded to set up user actions as in a screen 1810. Then, if a ‘store’ or ‘save’ button is selected, the controller 10 sets up and stores the user input list as user actions.

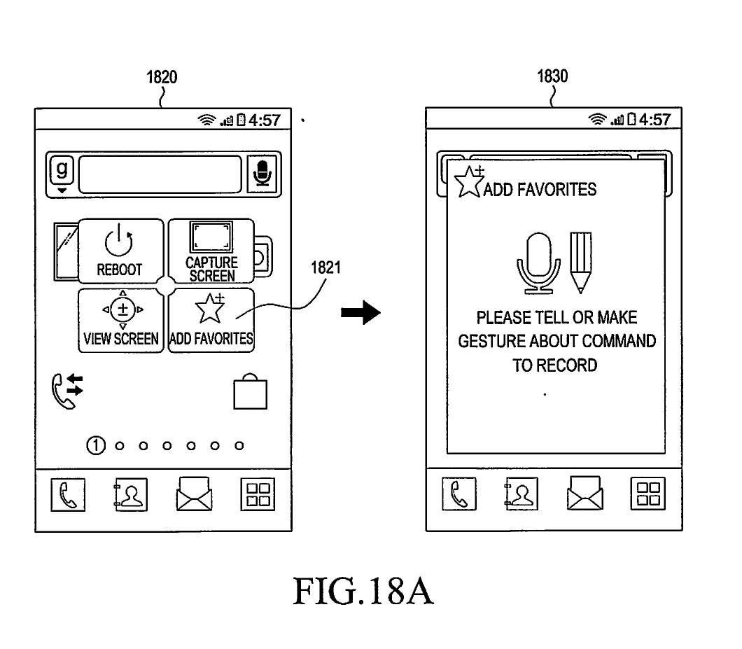

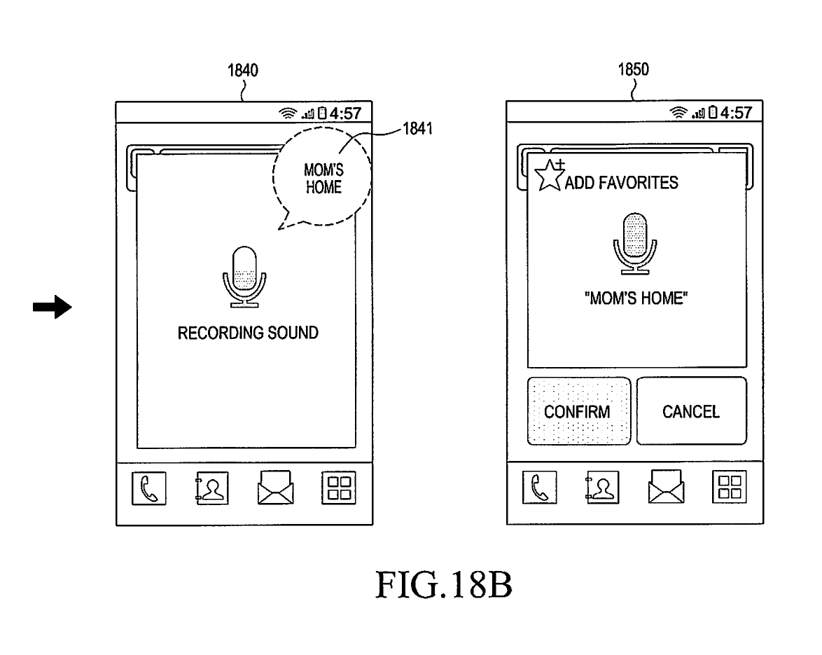

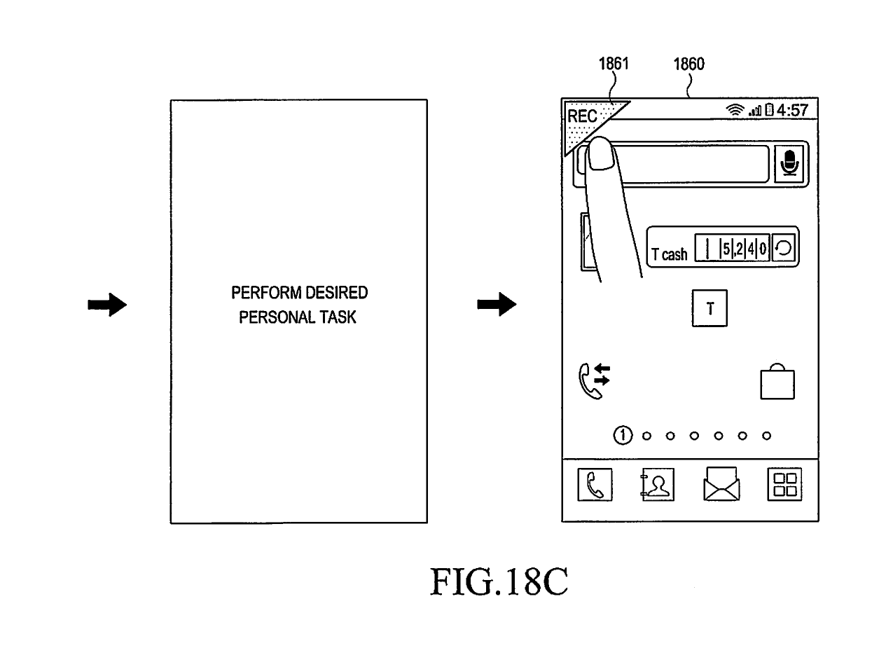

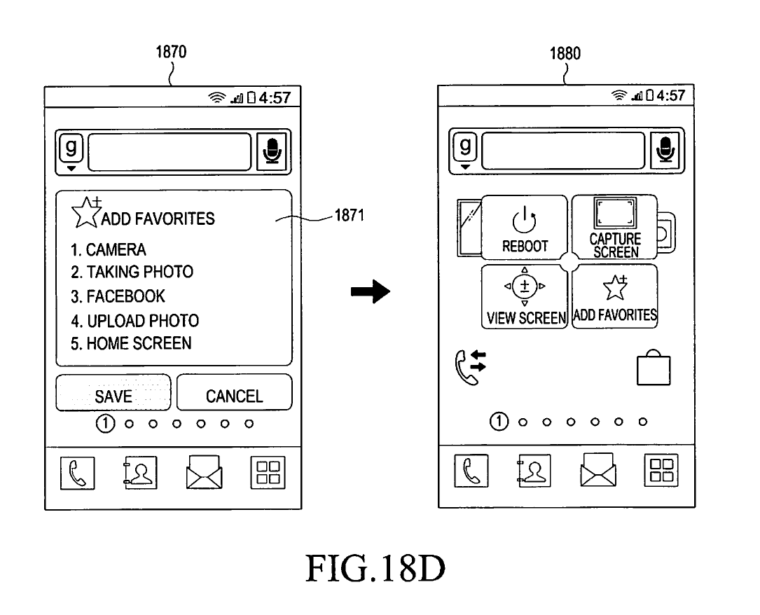

FIGS. 18A to 18D illustrate a process of setting up user actions that record user inputs in response to voice inputs through the floating user interface, according to an embodiment of the present invention.

Upon selection of the item menu ‘Add Favorites’ indicated by a reference numeral 1821, which is a terminal function menu to set up a user action to sequentially record user inputs in correspondence to the user-selected terminal function menu in the floating user interface as shown in a screen 1820 of FIG. 18A, the controller 10 displays an input screen to select a type of an operation to implement the user action as shown in a screen 1830.

If a voice input 1841, e.g., ‘mom's home’ is detected through a microphone as shown in a screen 1840 of FIG. 18B, the controller 10 displays a guiding screen to indicate that the voice input is being recorded as a voice command and displays a guiding message to confirm whether the voice input is correct as shown in a screen 1850.

When the user selects the ‘confirm’ button, the controller 10 displays a screen for recording user inputs that correspond to voice inputs. Specifically, the controller 10 displays a recording identifier to start recording user inputs, and starts recording a user input if the recording identifier is selected by the user input means. This recording process is similar to what was described in connection with FIGS. 17A and 17B.

If there are user inputs or selections made by the user input means, the controller 10 records the user inputs or the selections in an input sequence; and if there is an input to stop recording, the controller 10 stops recording the user input. For example, if the recording identifier as indicated by reference numeral 1861 is selected again by the user input means since the user input has been recorded as shown in a screen 1860 of FIG. 18C, the controller 10 determines the re-selection of the recording identifier as an input to stop recording user inputs and stops recording user inputs.

The controller 10 then displays the user input list, indicated by reference numeral 1871, which has been recorded to set up user actions, as shown in a screen 1870 of FIG. 18D. After that, when the ‘store’ or ‘save’ button is selected, the controller 10 sets up the user input list to be user actions and displays an initial screen of the floating user interface, as shown in a screen 1880.

In the foregoing embodiments in connection with FIGS. 17A to 17D and 18A to 18D, user actions are set up using gesture or voice inputs. However, in other embodiments, if there is a text input in setting up user actions, user inputs may be recorded in correspondence to the input text and then stored.

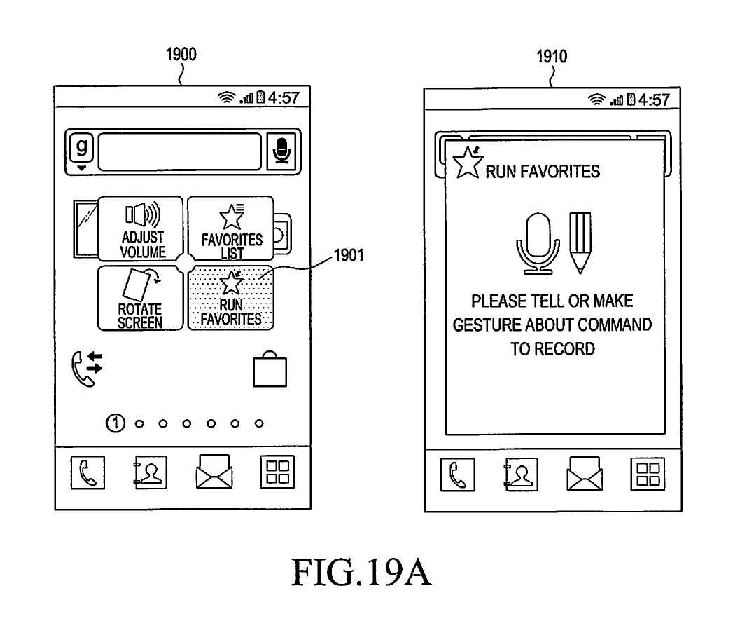

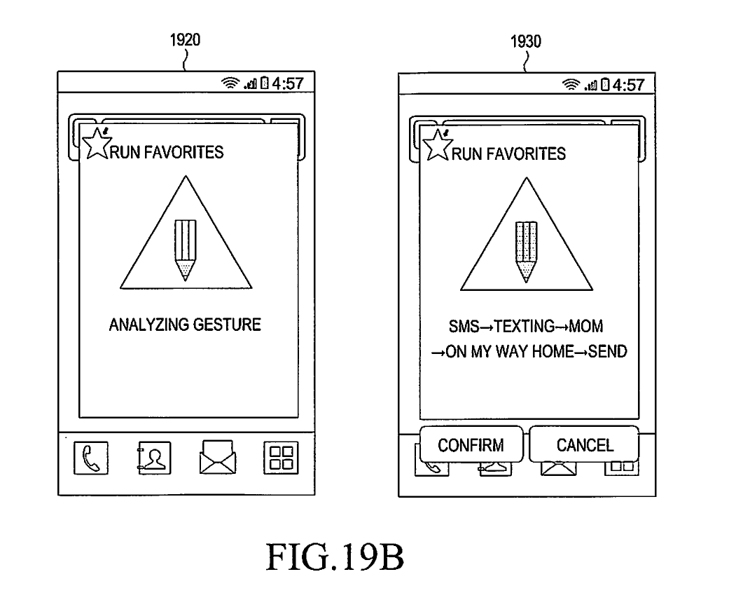

FIGS. 19A and 19B illustrate a process of executing user actions set up in response to gesture inputs, according to an embodiment of the present invention.

If a ‘run favorites’ menu 1901 for executing user actions in the floating user interface is selected by the user input means as shown in a screen 1900 of FIG. 19A, the controller 10 displays a screen to guide the user to make a voice input or a gesture input that corresponds to a user action to be executed among one or more user actions set up, as shown in a screen 1910.

When a gesture input corresponding to a user action to be executed is made, the controller 10 displays a screen including a guiding phrase, e.g., ‘analyzing gesture’ indicating that it is in the process of determining whether there is the user action set up to correspond to the gesture input, as shown in a screen 1920 of FIG. 19B. Specifically, the controller 10 determines whether there is a user action set up to correspond to an input gesture among one or more user actions stored in the storage 30. The input gesture refers to a writing shape input by the user, and the method of recognizing the writing shape employs a method of recognizing general touch inputs or writing inputs.

If there is the user action set up to correspond to the input gesture, the controller 10 displays a guiding screen of the user input list that corresponds to user actions, as shown in a screen 1930. For example, in response to a request for a selected terminal function menu, selection of a terminal function, selection of a contact to transmit a message, input of message description, execution of the terminal function, the user input list corresponding to the gesture may be displayed like ‘SMS->Texting->Mom->On my way home->Send’.

Then, if a ‘confirm’ input is made by the user input means to execute the user action, the controller 10 executes the user action. In other words, the controller 10 sends an SMS message including a message of ‘on my way home’ to the contact corresponding to ‘mom’ by executing the message send function based on the recorded user inputs.

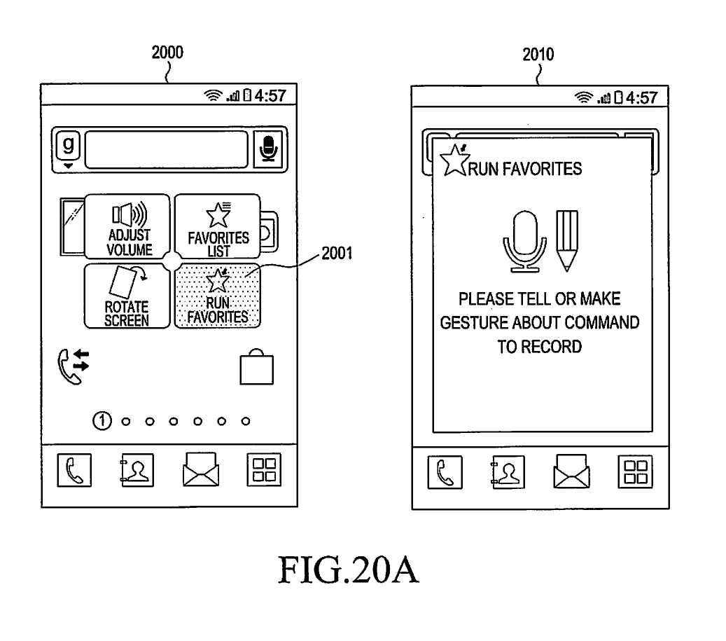

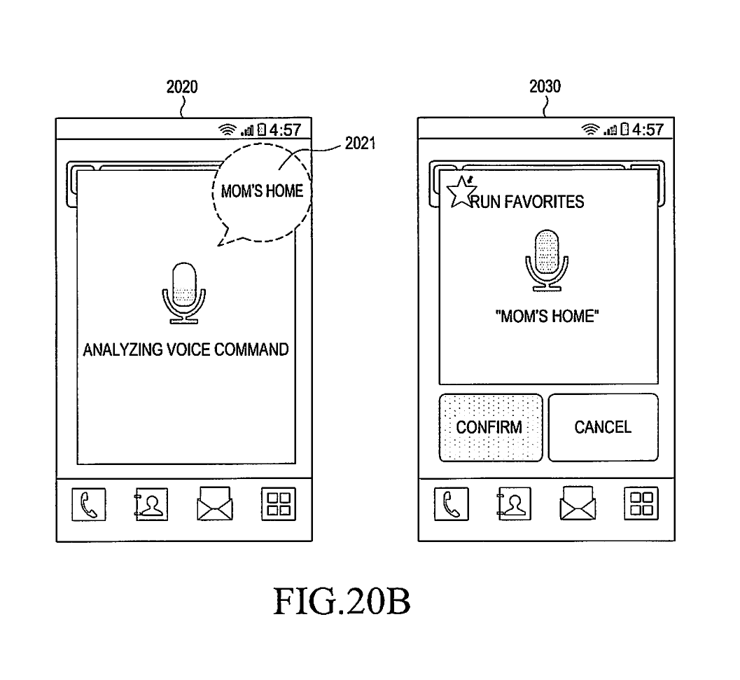

FIGS. 20A and 20B illustrate a process of executing a user action recorded in response to a voice input, according to an embodiment of the present invention.

If a menu item 2001 for executing user actions in the floating user interface is selected by the user input means as shown in a screen 2000 of FIG. 20A, the controller 10 displays a screen to guide the user to make a voice input or a gesture input that corresponds to a user action to be executed among one or more user actions set up, as shown in a screen 2010.

When a voice input corresponding to a user action to be executed is made, the controller 10 displays a screen including a guiding phrase, e.g., ‘analyzing voice command’ indicating that it is in the process of determining whether there is the user action set up to correspond to the voice input, as shown in a screen 2020 of FIG. 20B. Specifically, if a voice input, e.g., ‘mom's home’ is made as indicated by reference numeral 2021, the controller 10 determines whether there is a user action set up in correspondence to the voice input ‘mom's home’ among one or more user actions stored in the storage 30. In determining the voice input, a general voice recognition method is employed.

If there is the user action set up in correspondence to the input voice, the controller 10 displays a guiding message to inquire whether to execute the user action, a confirm button to execute the user action, and a cancel button to cancel the execution of the user action, as shown in a screen 2030.

Then, if the confirm button is selected by the user input means, the controller 10 executes the user action, or else if the cancel button is selected, the controller 10 displays the initial screen of the floating user interface.

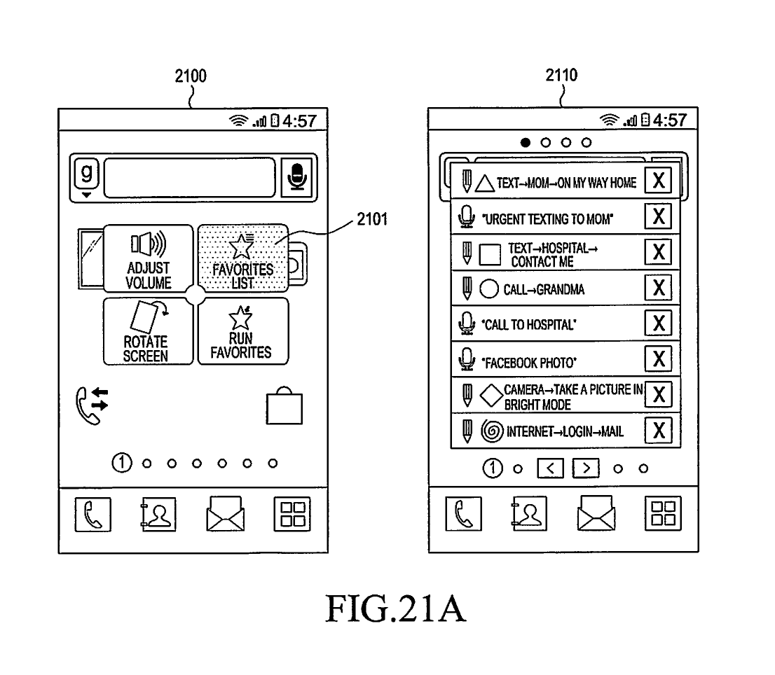

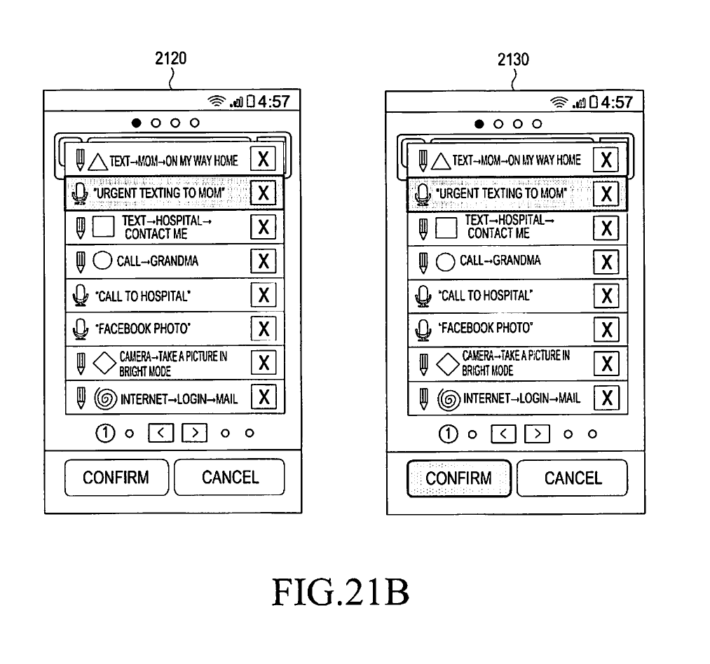

In the foregoing embodiments in connection with FIGS. 19A and 19B and 20A and 20B, processes of executing the user action set up in correspondence to the voice input or the gesture input was described. However, in other embodiments where user actions are set up in correspondence to text inputs, if a text input is made, a corresponding user action is searched and executed to perform operations recorded based on user inputs. FIGS. 21A and 21B illustrate a process of displaying a list of user actions set up through the floating user interface, according to an embodiment of the present invention.

If a terminal function menu, e.g., ‘favorites list’ 2101 to show a list of user actions set up in advance is selected as shown in a screen 2100 of FIG. 21A, the controller 10 displays a list of one or more user actions including as many user actions as determined in advance, which are stored in the storage 30, as shown in a screen 2110. Contents of the user action list displayed in the screen 2110 include icons representing the respective user actions set up in correspondence to gesture inputs or voice inputs, icons representing input gestures or words or phrases corresponding to brief summaries of voice inputs, recorded user input list, etc. The controller 10 may receive from the user input means the words or phrases corresponding to brief summaries of voice inputs and display them on the user action list. The controller 10 may also perform voice recognition on the input voice, convert the recognized voice to words or phrases, and display them on the user action list. If such contents are too many to be displayed in the floating user interface, the controller 10 may display part of the content for each user action of the user action list.

If a user action is selected by the user input means as shown in a screen 2120 of FIG. 21B, the controller 10 may continuously move and display setup contents for the entire user actions like an annunciator, while displaying the area in which setup contents for the selected user action are displayed in a particular color.

Then, if a ‘confirm’ input is made by the user input means to execute the selected user action as shown in a screen 2130, the controller 10 executes the user action. In other embodiments of the present invention, the user action may be executed not only by the ‘confirm’ button but also by double clicks on the user action, a touch input on the user action for a predetermined time, a dwell input that stays stationary without cursor clicking, or a hovering input that stays stationary without finger touching.

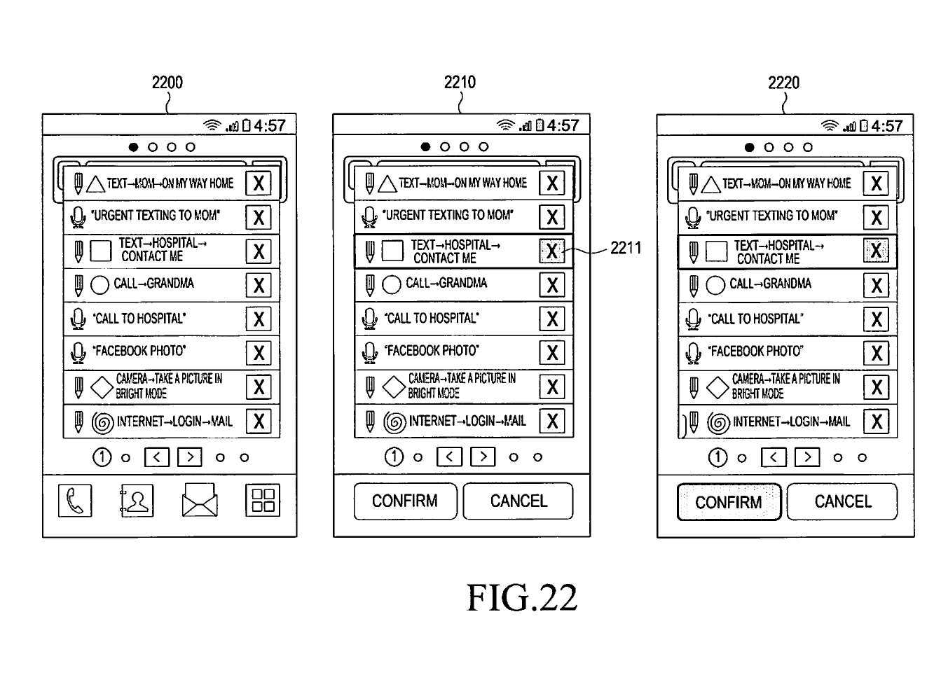

FIG. 22 illustrates a process of deleting a list of user actions through the floating user interface, according to an embodiment of the present invention.

If the user action list is displayed as shown in a screen 2200 and a particular user action is selected by the user input means to be deleted from the user action list, the controller 10 displays a delete button 2211 in a particular color to represent that the corresponding user action is to be deleted as shown in a screen 2210. In this case, user actions on the list may be displayed together with respective delete buttons.

If the ‘confirm’ button is selected by the user input means to delete the selected user action as shown in the screen 2200, the controller 10 deletes the selected user action from the list.

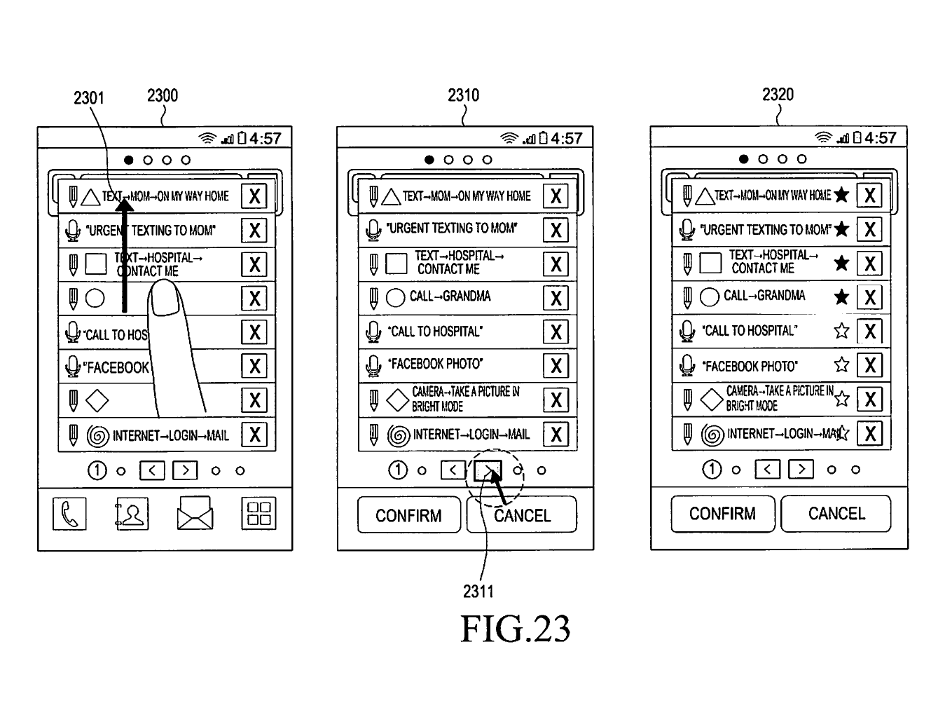

FIG. 23 illustrates a process of navigating and moving the user actions through the floating user interface, according to an embodiment of the present invention.

In a screen 2300 where the user action list is displayed, if a touch-and-drag input is detected in the direction indicated by reference numeral 2301, the controller 10 determines the dragging direction 2301 of the touch-and-drag input and displays the user action items on the user action list while scrolling them in the dragging direction. For example, where thirty user action items are contained in the user action list while there are eight user action items to be displayed in the floating user interface, the controller 10 displays eight user action items on the screen among user action items arranged in a predetermined order. The controller 10 may arrange and display recently setup user action items in upper part of the user action list in the predetermined order. If there is a request to display user action items arranged next to the currently displayed eight user action items, the controller 10 displays the user action items sequentially at the request. When a touch-and-drag input is made by the user's finger, the controller 10 may display some user action items while moving the user action list in the dragging direction.

As shown in a screen 2310 where a scroll key button 2311 to move pages of user action lists is provided, if a mouse pointer is detected on the scroll key button 2311, the controller 10 may scroll and display the user action list in the direction that corresponds to the scroll key direction. Such page moving is similar to the foregoing menu page shifting. If a selection of the mouse pointer on the scroll key button is made, the controller 10 may move the menu pages faster than the former case of page moving.

When a frequently-used user action item is selected, the controller 10 may set up the user action item to be placed on top of the user action list. As shown in a screen 2320, upon selection of frequently-used user action items, the controller 10 may classify the frequently-used user action items from others on the user action list and display them separately. For example, the controller 10 may classify the frequently-used user action items selected by the user input means from others on the list and display them on the upper part of the user action list. When there is a touch input to select a frequently-used user action on the user action list, the controller 10 may mark the selected user action item with a star-shaped icon and then classify user action items with such star-shaped icons into a separate group and store the group.

Alternatively, the controller 10 may determine which user action items are frequently used by the user and display them to be placed on the upper part of the user action list by default.

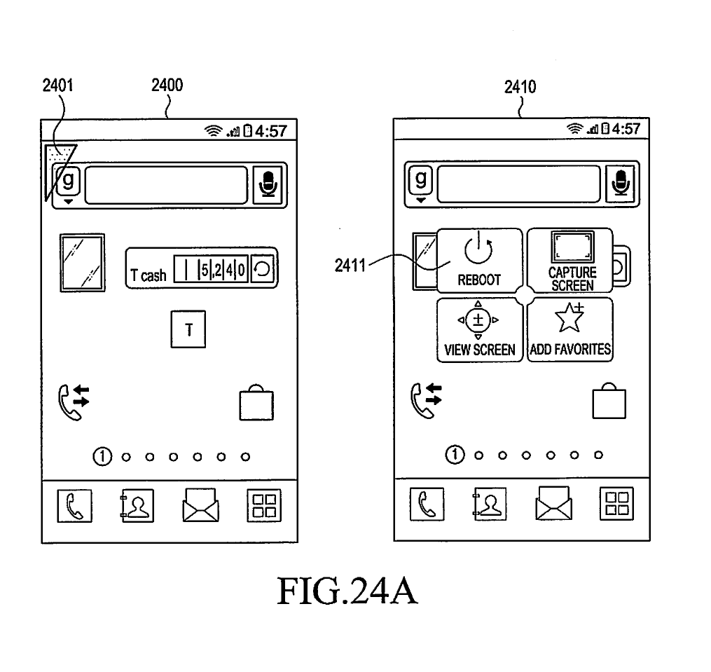

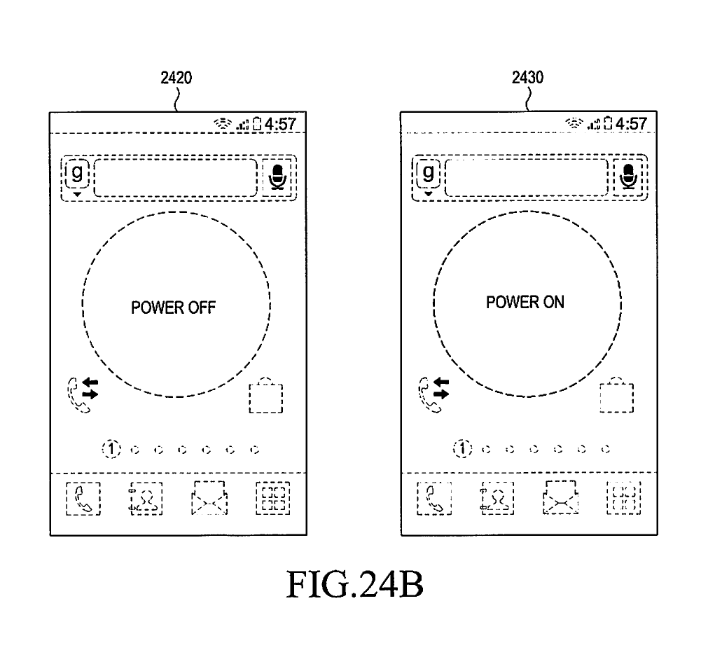

FIGS. 24A and 24C illustrate a process of executing a reboot menu 2411 through the floating user interface, according to an embodiment of the present invention.

If an identifier 2401 to run the floating user interface is selected by the user input means in a screen 2400 of FIG. 24A, the controller 10 displays the floating user interface that contains a plurality of menu items as shown in a screen 2410.

Then, the reboot menu 2411 to reboot the terminal is selected by the user input means, the controller 10 powers off the terminal and then power it back on. In the case of powering off the terminal, the controller 10 displays a screen to indicate that the power is off as shown in a screen 2420 of FIG. 24B; otherwise, in the case of powering on the terminal again, the controller 10 displays a screen to indicate that the power is on as shown in a screen 2430.

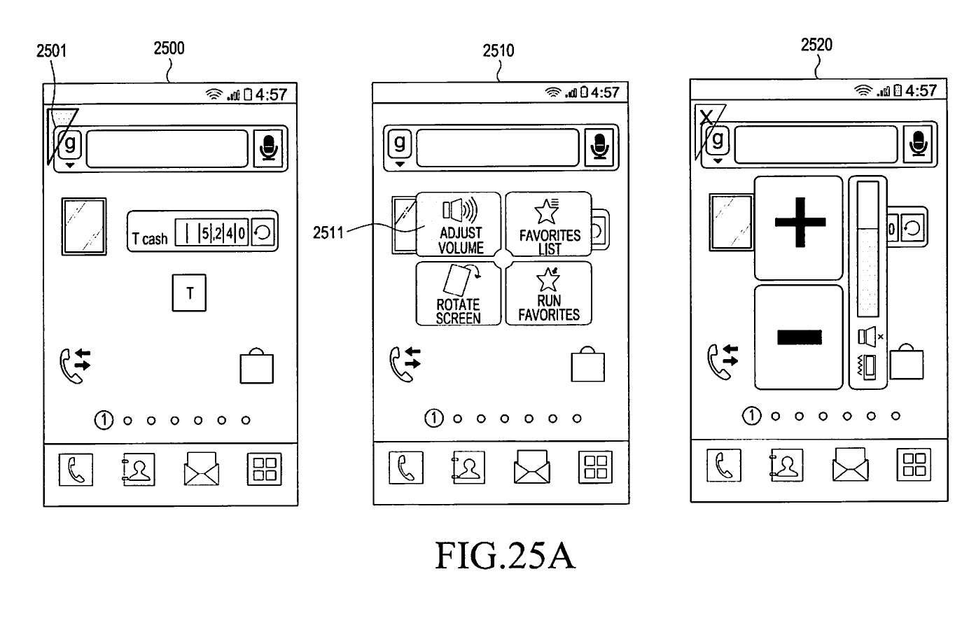

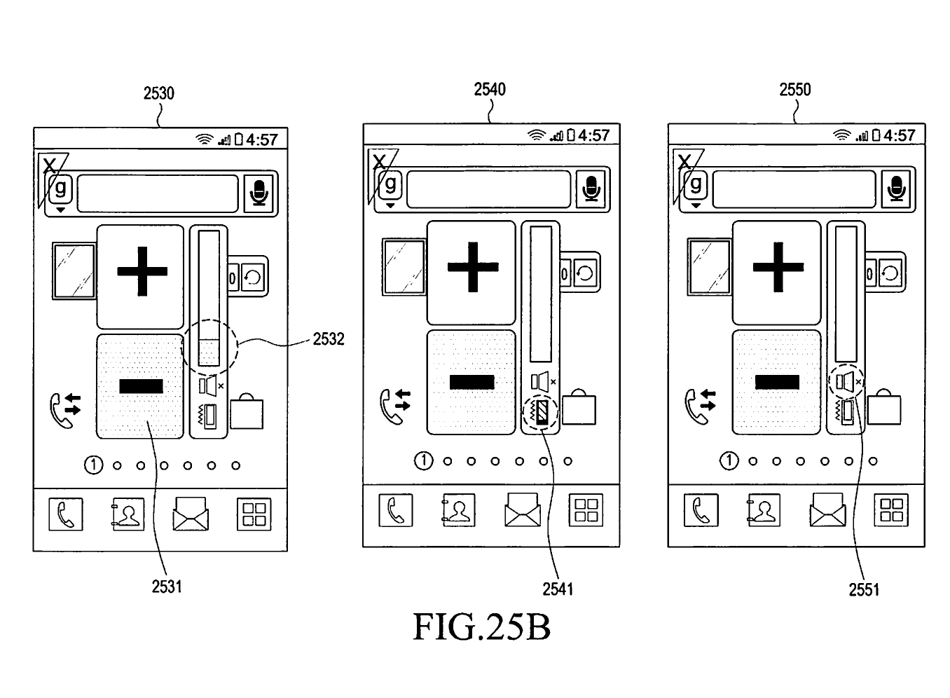

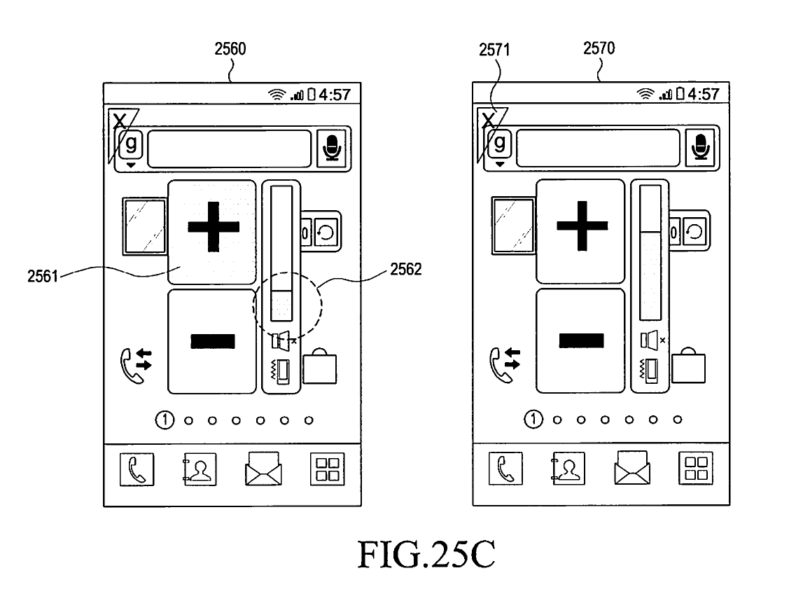

FIGS. 25A to 25B illustrate a process of executing a ringtone volume adjustment menu through the floating user interface, according to an embodiment of the present invention.

If an identifier 2501 to run the floating user interface is selected by the user input means in a screen 2500 of FIG. 25A, the controller 10 displays the floating user interface that contains a plurality of menu items as shown in a screen 2510.

When the ‘adjust volume’ menu 2511 to adjust the speaker volume of the terminal is selected by the user input means, the controller 10 displays volume up (+) and down (−) buttons to adjust the volume with a volume status bar, as shown in a screen 2520.

If the volume down button, indicated by reference numeral 2531 in a screen 2530, is selected, the controller 10 reduces the speaker volume of the terminal and displays the volume status bar, indicated by reference numeral 2532, to correspond to the reduced volume.

If the user input means keeps selecting the volume down button until nothing is left to be reduced in the volume status bar 2532, the controller 10 changes the terminal from the ringtone mode to a vibration mode and displays a vibration indicator icon 2541 to indicate that the terminal is in the vibration mode, as shown in a screen 2540. In the ringtone mode the terminal outputs bell sounds through the speaker of the terminal, while in the vibration mode the terminal outputs vibration without outputting a bell sound through the speaker.

If the user keeps selecting the volume down button with the user input means, the controller 10 changes the terminal from the vibration mode to a silent mode and displays a silence indicator icon 2551 to indicate that the terminal is in the silent mode. In the silent mode, the terminal does not vibrate or output a sound through the speaker. Proportions of volume up or volume down of the terminal in response to the volume up or volume down input are determined beforehand. For example, if the current speaker volume of the terminal is less than a threshold, the controller 10 may perform an operation of entering into the silent mode. Otherwise, if the current speaker volume of the terminal is greater than or equal to the threshold, the controller 10 may change the terminal from the silent mode to the ringtone mode. Furthermore, if the vibration indicator icon 2541 or the silence indicator icon 2551 is selected by the user input means, the controller 10 may directly set the vibration mode or the silent mode. In addition, upon detection of a touch input or a pointing input on a particular position of the volume status bar, the controller 10 may increase or reduce the volume of the speaker to a volume that corresponds to the particular position.

If the volume up button, as indicated by reference numeral 2561, is selected by the user input means as shown in a screen 2560 of FIG. 25C, the controller 10 changes the terminal from the silent mode to the vibration mode. If the user keeps selecting the volume up button with the user input means, the controller 10 changes the terminal from the vibration mode to the ringtone mode and displays the volume status bar 2562 to reflect the increased volume.

After that, if the user selects an identifier, indicated by reference numeral 2571, to stop adjusting the speaker volume as shown in a screen 2570, the controller 10 stops adjusting the speaker volume and displays the initial screen of the floating user interface.

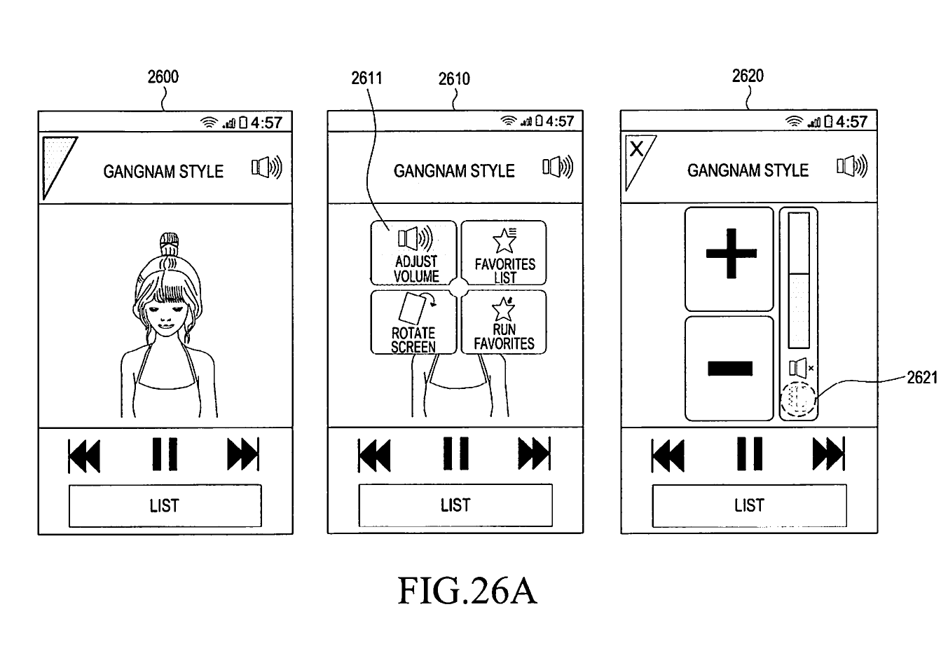

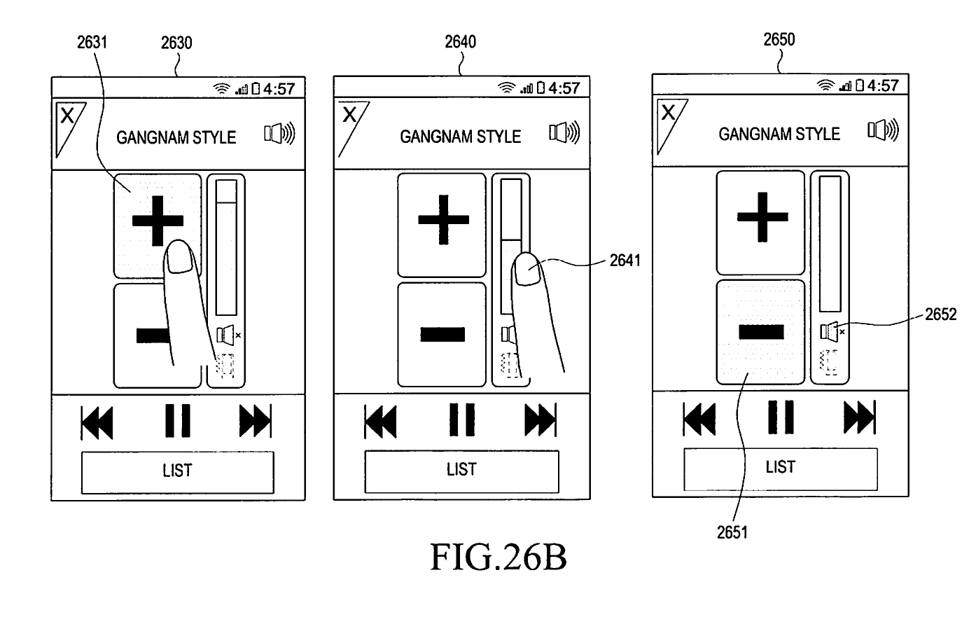

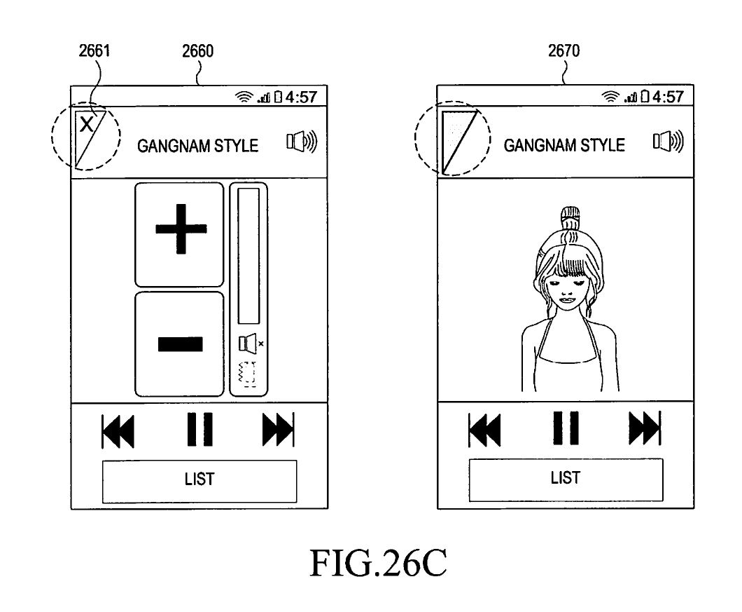

FIGS. 26A to 26C illustrate a process of executing an adjust multimedia volume menu through the floating user interface, according to an embodiment of the present invention.

If an identifier to run the floating user interface is selected by the user input means while a multimedia play application is running as shown in a screen 2600 of FIG. 26A, the controller 10 displays the floating user interface that contains a plurality of menu items as shown in a screen 2610.

When an ‘adjust volume’ menu 2611 to adjust the volume of multimedia being played is selected by the user input means, the controller 10 displays volume up (+) and down (−) buttons to adjust the volume with a volume status bar, as shown in a screen 2620. In adjusting the volume for the multimedia being played, the controller 10 activates the silent mode while deactivating the vibration mode, as indicated by reference numeral 2621.

If the volume up button, indicated by reference numeral 2631, is selected, as shown in a screen 2630 of FIG. 26B, the controller 10 increases the volume of the multimedia being played and displays the volume status bar to correspond to the increased volume.

If a touch-and-drag input 2641 over the volume status bar is detected as shown in a screen 2640, the controller 10 reduces or increases the volume based on the dragging direction while displaying the volume status bar to correspond to the reduced or increased volume.

If the volume down button, indicated by reference numeral 2651, is selected as shown in a screen 2650, the controller 10 reduces the volume of the multimedia being played and displays the volume status bar to correspond to the reduced volume.

If the user input means keeps selecting the volume down button 2651 until nothing is left to be reduced in the volume status bar, the controller 10 changes the multimedia volume to be in a silent mode and displays a silence indicator icon 2652 to indicate that the multimedia volume is silent, as shown in a screen 2650.

If the user selects an identifier 2661 to stop adjusting the multimedia volume as shown in a screen 2660 of FIG. 26C, the controller 10 stops adjusting the multimedia volume and displays the initial screen of the floating user interface as shown in a screen 2670.

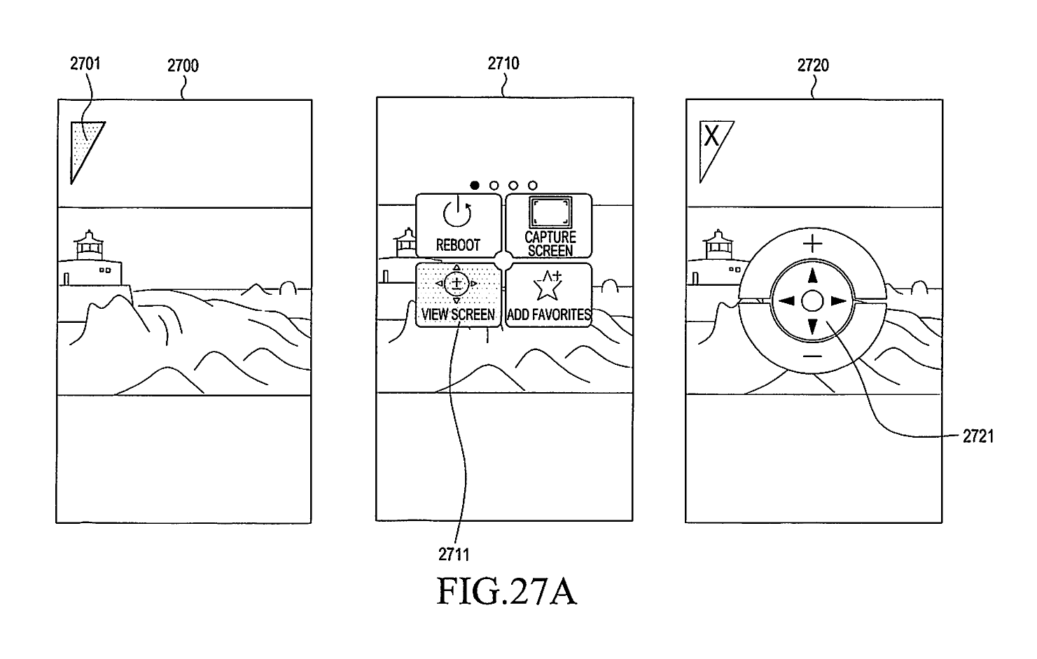

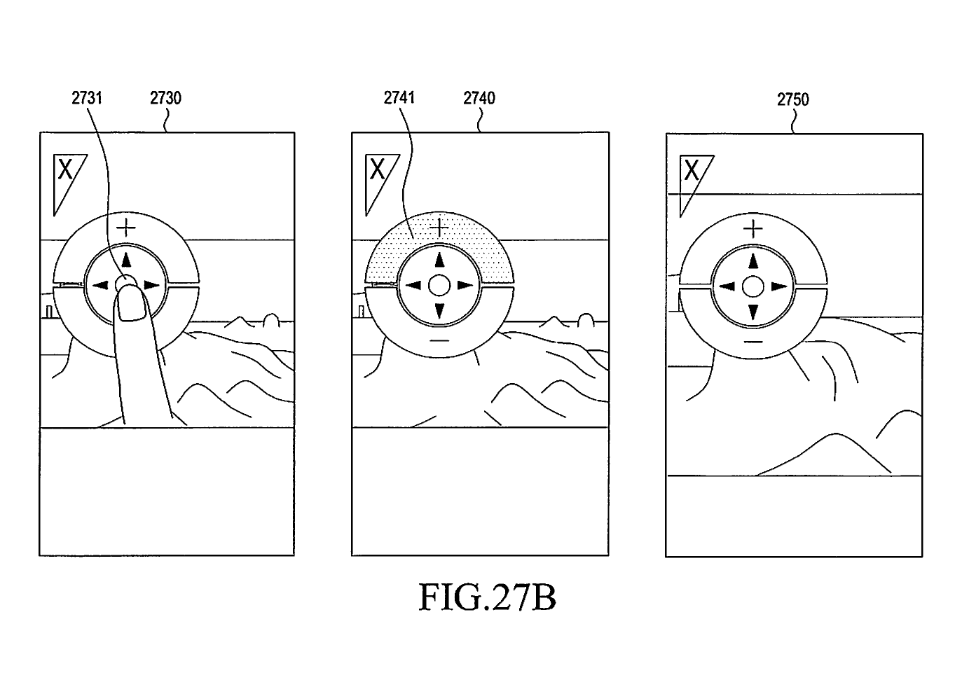

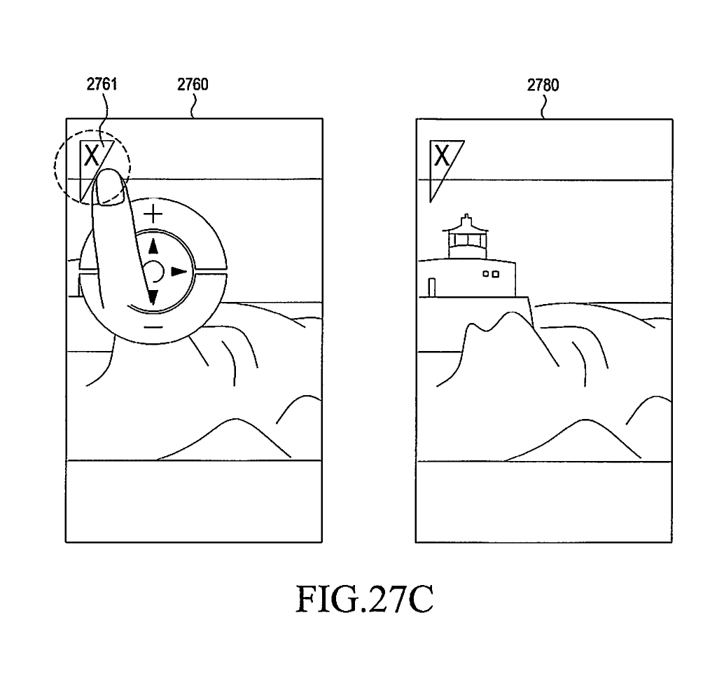

FIGS. 27A to 27C illustrate a process of executing a zoom-in or zoom-out menu through the floating user interface, according to an embodiment of the present invention.

Described in the embodiment is a process of performing an operation of zooming in or zooming out an image using the floating user interface while the image reproducing application is running.

If an identifier 2701 to run the floating user interface is selected by the user input means while a multimedia play application is running as shown in a screen 2700 of FIG. 27A, the controller 10 displays the floating user interface that contains a plurality of menu items as shown in a screen 2710.

If a ‘view screen’ menu 2711, which is a terminal function menu to adjust the screen size is selected in the floating user interface as shown in the screen 2710, the controller 10 generates and displays a screen adjustment icon 2721 to adjust the screen as shown in a screen 2720. As shown in the screen 2720, the screen adjustment icon 2721 may have a radial shape in a predetermined size and includes up, down, left, and right directional key areas and zoom-in or zoom-out key areas.

If a touch-and-drag input is detected over a moving area 2731 in a predetermined size which is located at the center of the screen adjustment icon as shown in a screen 2730 of FIG. 27B, the controller 10 determines the dragging direction based on the detected touch-and-drag input, and moves and displays the screen adjustment icon in the dragging direction. In particular, the user input means that made the touch and the moving area are displayed to be mapped to each other. With this, the user is able to move the screen adjustment icon to a position on a screen based on which to perform zooming-in or zooming-out.

If a zoom-in key area 2741 is selected as shown in a screen 2740, the controller 10 displays the screen by zooming in the screen centered at the screen adjustment icon as shown in a screen 2750.

After that, if an identifier 2761 to stop zooming-in or zooming-out is selected as shown in a screen 2760 of FIG. 27C, the controller 10 stops displaying the screen adjustment icon and changes the screen as shown in a screen 2780.

In the foregoing embodiment, the radial-shaped screen adjustment icon was illustrated; however, the screen adjustment icon may be implemented in various other shapes. Also, in the foregoing embodiment, it was described that the zoom-in or zoom-out operation was performed while the image play application is running, but the zoom-in or zoom-out operation may be performed on any other screens.

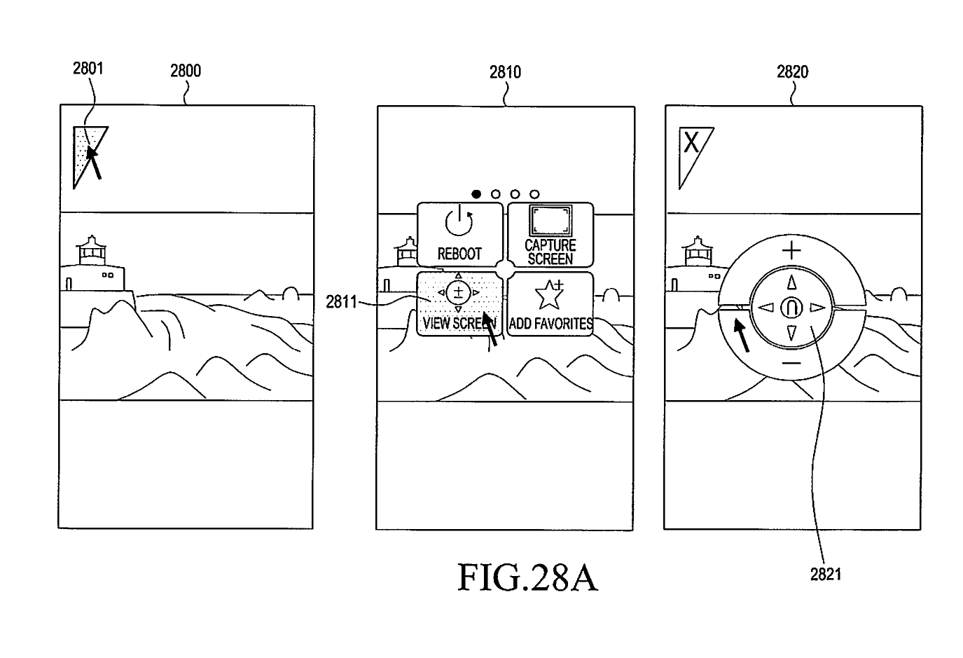

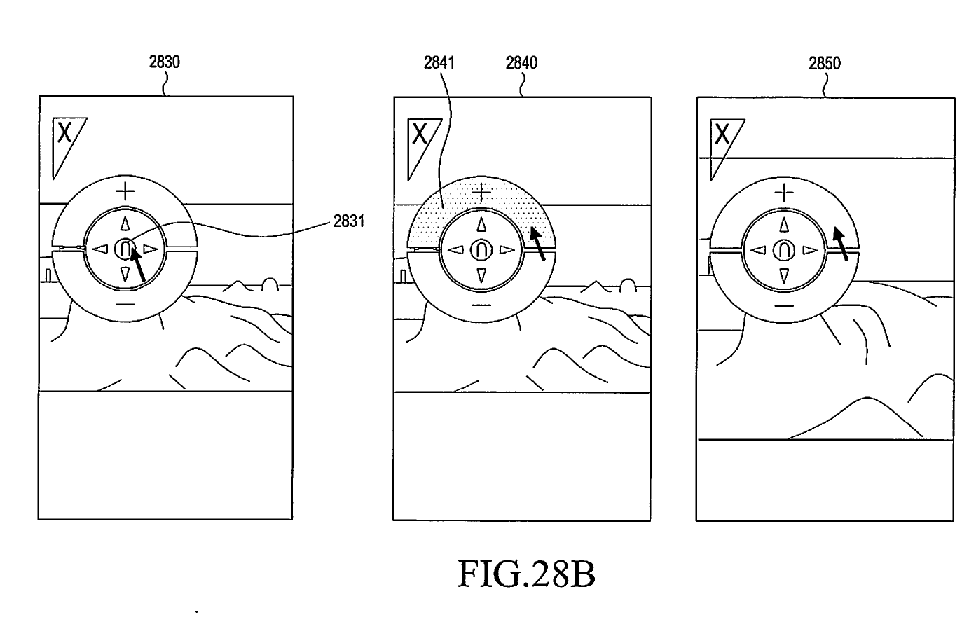

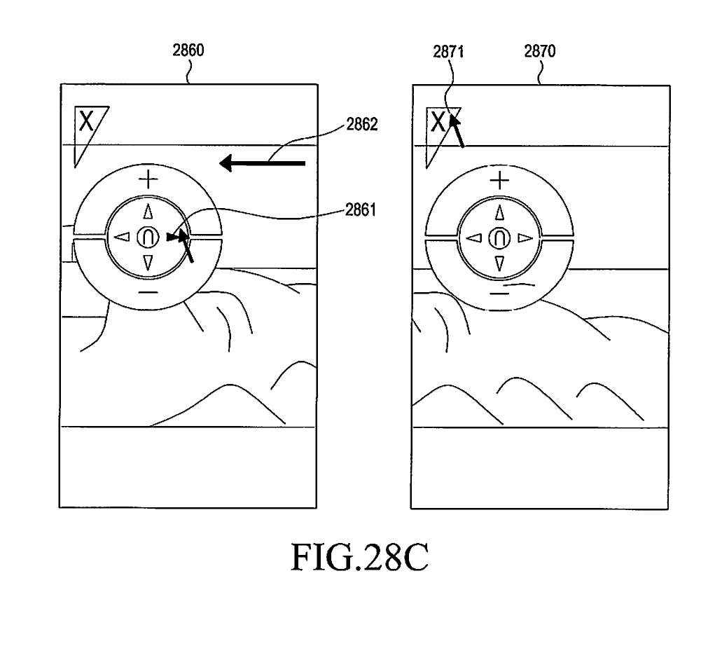

FIGS. 28A to 28C illustrate a process of executing a zoom-in or zoom-out menu through a floating user interface using a mouse, according to an embodiment of the present invention.

If an identifier 2801 to run the floating user interface is selected by mouse pointing in a screen 2800 of FIG. 28A, the controller 10 displays the floating user interface that contains a plurality of menu items as shown in a screen 2810.

After that, if a ‘view screen’ menu 2811 is selected by mouse pointing, the controller 10 displays a screen adjustment icon 2821 to adjust the screen, as shown in a screen 2820.

As shown in a screen 2830 of FIG. 28B, if a moving area 2831 in a predetermined size, which is positioned at the center of the screen adjustment icon is selected by mouse pointing, the controller 10 maps the moving area 2831 with the mouse pointing, moves and displays the screen adjustment icon according to the movement of the mouse pointing from where the mapped moving area 2831 is placed. If the moving area 2831 is re-selected by mouse pointing, the controller 10 may release the mapping relationship between the mouse pointing and the moving area 2831.

If a mouse pointer is placed within the zoom-in key area 2841 and the zoom-in key area 2841 is selected by mouse pointing as shown in a screen 2840, the controller 10 displays the screen by zooming in the screen centered at the screen adjustment icon as shown in a screen 2850. In other embodiments, upon detection of a mouse pointer within the zoom-in key area 2841, the controller 10 may display the screen by zooming in the screen at a predetermined speed. In other embodiments where the mouse pointer is placed within the zoom-in key area 2841 and the zoom-in key area 2841 is selected by mouse pointing, the controller 10 may display the screen by zooming in the screen at a faster speed than the former case.

Upon detection of mouse pointing in a right scroll key area 2861 among the up, down, left, and right scroll key areas as shown in a screen 2860 of FIG. 28C, the controller scrolls and displays the screen in the opposite direction of the selected right direction. If any of the up, down, left, and right scroll key areas is selected by a mouse pointer, the controller 10 may scroll and display the screen in the selected direction at faster speed than the former screen moving speed. In other embodiments, similar to the page moving function based on selection of the scroll key area by the mouse pointer, the controller 10 may perform a page shift function for changing images currently displayed on the screen to other images.

After that, if an identifier 2871 to stop zooming-in or zooming-out is selected as shown in a screen 2870, the controller 10 stops displaying the screen adjustment icon and changes the screen to a screen where a zoomed-in image is displayed.

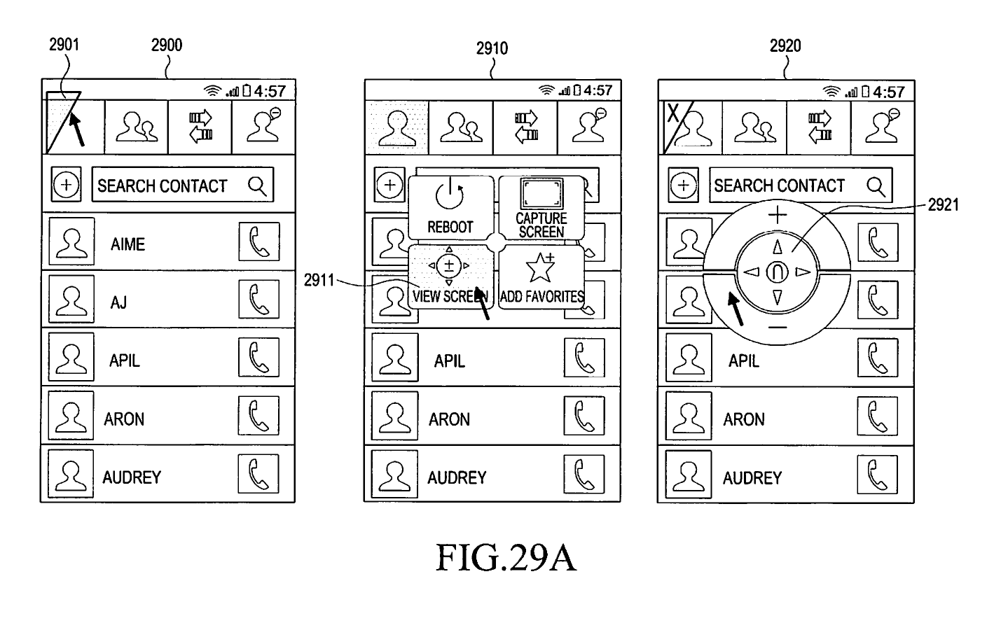

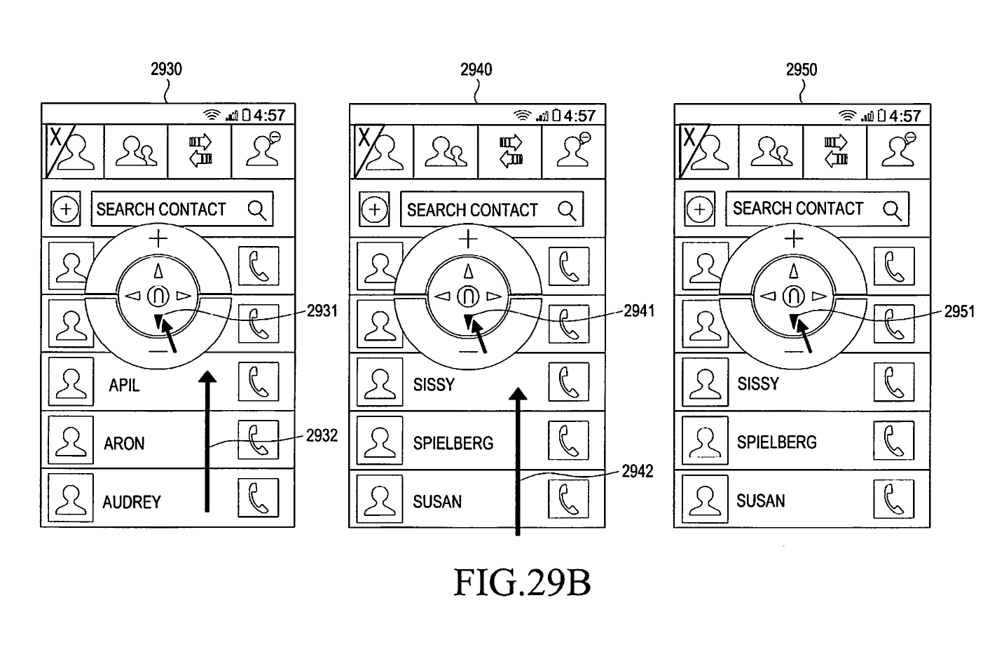

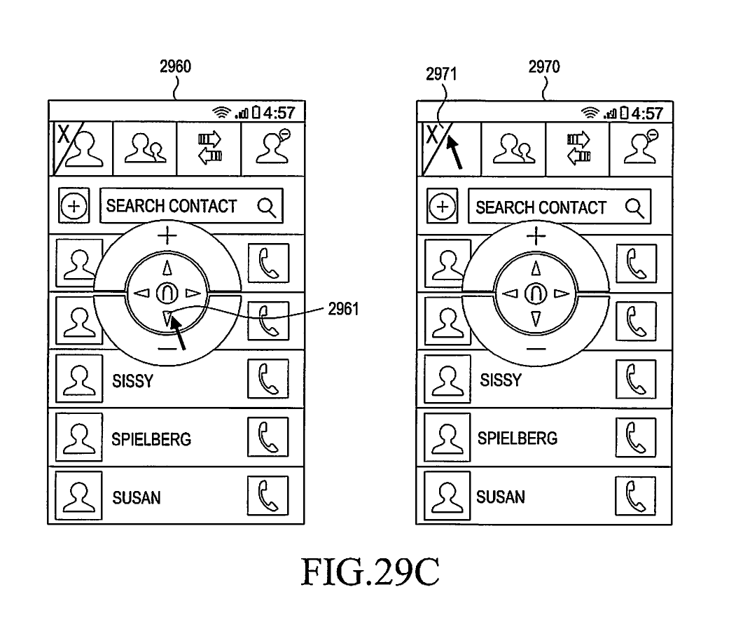

FIGS. 29A to 29C illustrate a process of executing a page shift menu through the floating user interface using the mouse, according to an embodiment of the present invention.

In the embodiment, the terminal runs a contact application and the resulting contact list is displayed on the screen.

If an identifier 2901 to run the floating user interface is selected by the user input means while the contact application is running and the resultant contact list is displayed as shown in a screen 2900 of FIG. 29A, the controller 10 displays the floating user interface that contains a plurality of menu items as shown in a screen 2910.

If a ‘view screen’ menu 2911, which is a terminal function menu to shift pages is selected in the floating user interface as shown in the screen 2910, the controller 10 generates and displays a page shift icon 2921 to shift pages as shown in a screen 2920. Similar to the foregoing screen adjustment icon, the page shift icon 2921 includes up, down, left, and right scroll key areas and zoom-in and zoom-out key areas. The zoom-in and zoom-out key areas may be determined to be activated and displayed depending on whether the background screen is scalable or not. Specifically, if the background screen is scalable, the zoom-in and zoom-out key areas are activated and displayed; otherwise, if the background screen is not scalable, the zoom-in and zoom-out key areas are not activated nor displayed.

Upon detection of a mouse pointer on a down scroll key area 2931 among the up, down, left, and right scroll key areas as shown in a screen 2930 of FIG. 29B, the controller 10 scrolls and displays a plurality of contacts included in the contact list in the opposite direction 2932 of the down direction for the down scroll key area 2931. The shifting speed may be determined in advance, and the contact list may be shifted and displayed at the predetermined shifting speed. The controller 10 may also display the scroll key area by changing the color of the scroll key area to indicate that a mouse pointer is detected in the scroll key area.

Upon selection of the down scroll key area 2941 by the mouse pointer as shown in a screen 2940, the controller 10 keeps scrolling the contacts in the opposite direction 2942 of the down direction for the down scroll key at faster shifting speed than the former case. The selection by means of the mouse pointer may be a mouse clicking input.

If a down directional key area 2951 is re-selected by the mouse pointer as shown in a screen 2950, the controller 10 stops moving contacts included in the contact list.

If a down directional key area 2961 is re-selected by the mouse pointer as shown in a screen 2960 of FIG. 29C, the controller 10 changes and displays the page shift icon into the initial state. Here, the controller 10 displays the scroll key area by recovering the original color of the scroll key area to indicate that the page shift icon has been changed into its initial state. If an identifier 2971 to stop shifting pages is selected as shown in a screen 2970, the controller 10 stops displaying the page shift icon and displays the contact application screen.

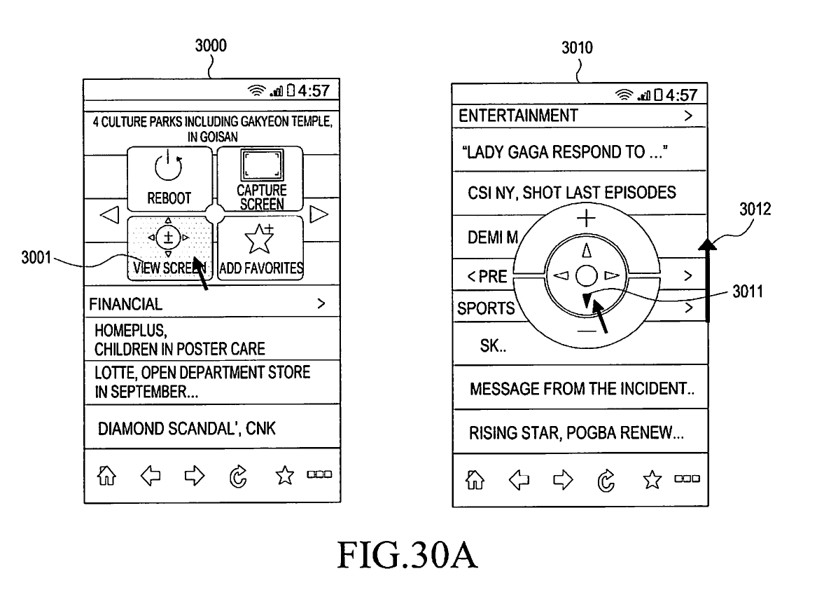

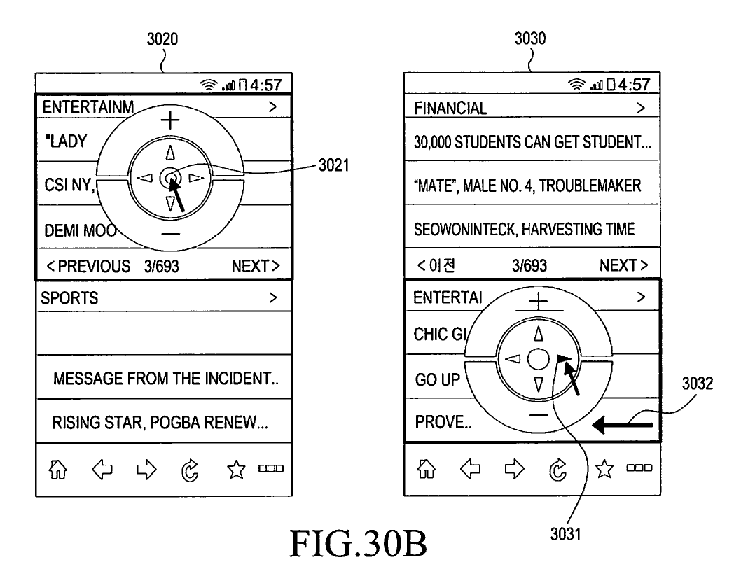

FIGS. 30A and 30B illustrate a process of moving pages based on the position of the page shift icon in executing to move pages using a mouse, according to an embodiment of the present invention.

In the embodiment, the full screen of the display unit includes a plurality of screen display areas. In particular, in the embodiment, the full screen includes a first screen display area and a second screen display area, the first screen display area being placed in a upper part of the full screen and the second screen display area being placed in a lower part of the full screen.

If there is an input to run the floating user interface by the user input means while a list of different topics of articles is displayed in two screen display areas as shown in a screen 3000 of FIG. 30A, the controller 10 displays the floating user interface including a plurality of menu items on the screen.

If a ‘view screen’ menu 3001, which is a terminal function menu to move pages is selected, the controller 10 generates and displays a page shift icon to move pages as shown in a screen 3010.

Upon detection of mouse pointing in a down scroll key area 3011 among up, down, left, and right scroll key areas in the screen 3010, the controller 10 scrolls and displays the entire article list in the opposite direction 3012 of the down direction for the down scroll key. In other words, the controller 10 scrolls and displays the entire screen list in correspondence to a detected direction on the full screen including a plurality of screen display areas. At this time, the controller 10 determines to scroll the entire screen list if proportions of respective page shift icon areas that are displayed in the respective screen display areas are similar. Here, the controller 10 determines that the proportions are similar if the difference in size of the page shift icon areas to be displayed in the respective screen display areas are less than a predetermined minimum threshold.

As shown in a screen 3020 of FIG. 30B, if a moving area 3021 in a predetermined size, which is positioned at the center of the page shift icon is selected by mouse pointing, the controller 10 maps the moving area 3021 with the mouse pointing, moves and displays the page shift icon according to the movement of the mouse pointing from where the mapped moving area 3021 is placed. In this embodiment, the controller 10 may display outlines of a screen display area in which the page shift icon is included to be bold or in a particular color to be discerned from other screen display areas. However, in other embodiments, different ways of marking the screen display area to be discerned from others may also be possible. Furthermore, if the difference between the corresponding screen display area and the area occupied by the page shift icon is greater than a predetermined maximum threshold, the controller 10 determines that the page shift icon is included in a screen display area having a big difference from the page shift icon.

As shown in a screen 3030 where there are two screen display areas displaying financial articles in the first screen display area and entertainment articles in the second screen display area and the page shift icon is placed in the second screen display area, upon detection of mouse pointing on the right scroll key area 3031 among the up, down, left, and right scroll key areas, the controller 10 scrolls and displays the entertainment articles in the opposite direction 3032 of the right direction for the right scroll key area.

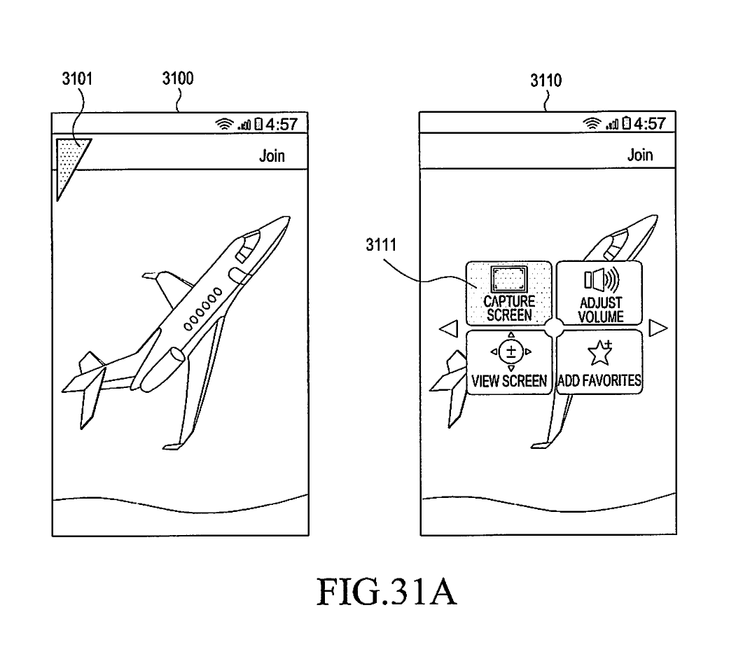

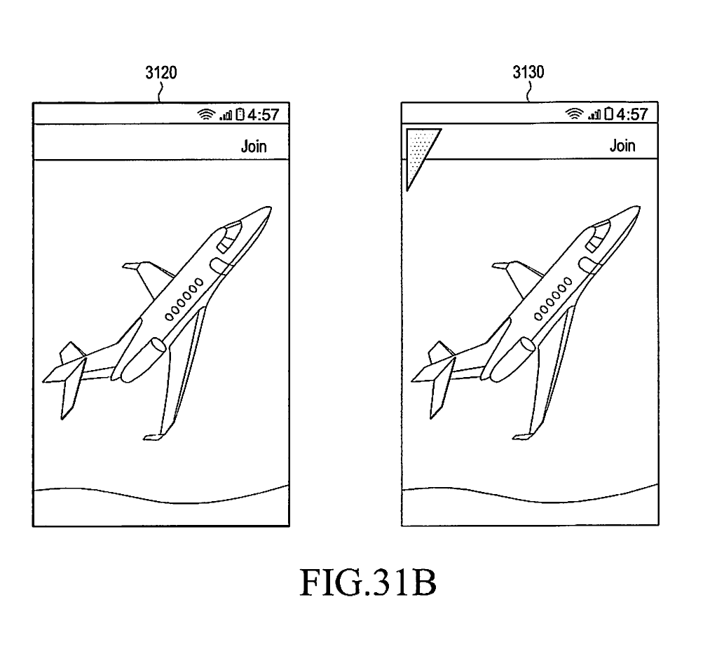

FIGS. 31A and 31B illustrate a process of executing a capture screen menu through the floating user interface, according to an embodiment of the present invention.

If an identifier 3101 to run the floating user interface is selected by the user input means while an Internet web site screen is being displayed as shown in a screen 3100 of FIG. 31A, the controller 10 displays the floating user interface that contains a plurality of menu items as shown in a screen 3110.

If the ‘capture screen’ menu 3111, which is a terminal function menu to capture a screen is selected, the controller 10 captures a currently displayed screen as shown in a screen 3120 of FIG. 31B, stores the captured screen image in the storage 30, and completes the screen capture. In this embodiment, the controller 10 may display a guiding phrase or guiding display to represent that the screen is being captured.

After that, the controller 10 displays an initial screen of the Internet web site as in a screen 3130.

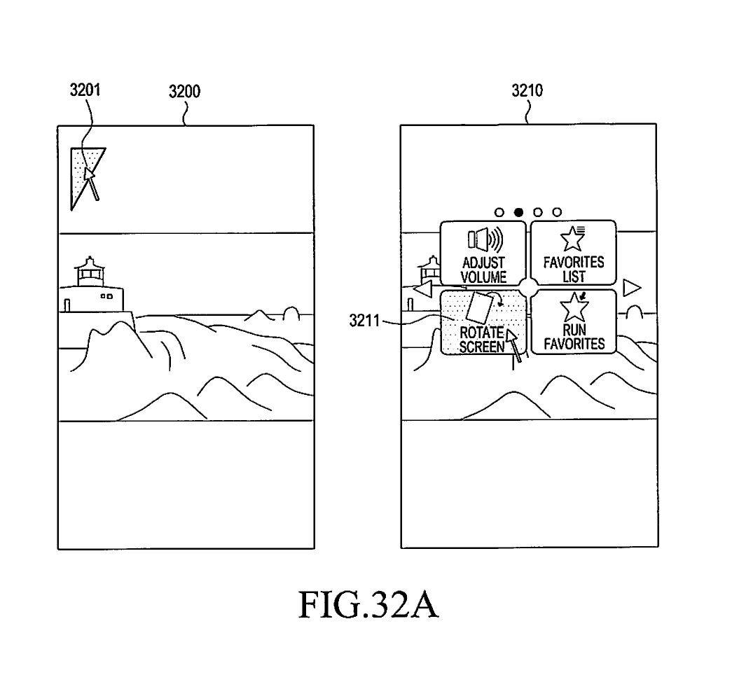

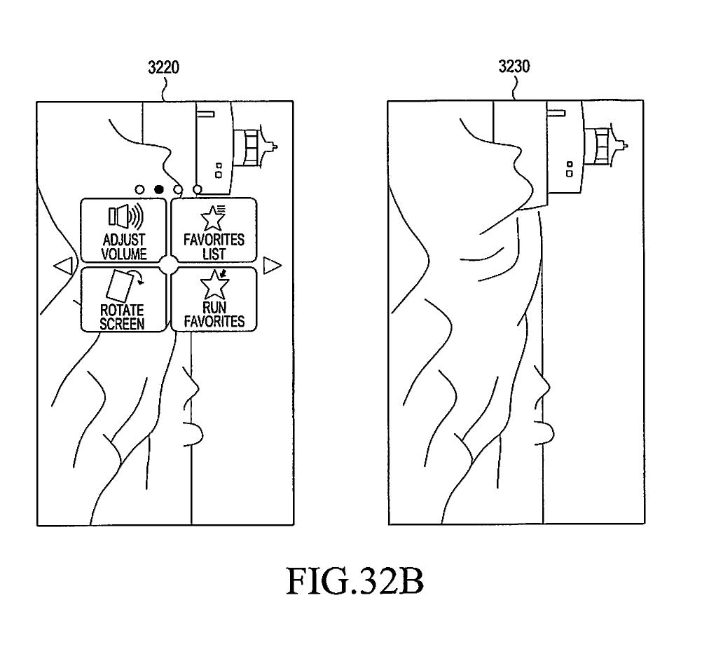

FIGS. 32A and 32B illustrate a process of executing a rotate screen menu through the floating user interface, according to an embodiment of the present invention.

If an identifier 3201 to run the floating user interface is selected by the user input means while an image is being reproduced as shown in a screen 3200 of FIG. 32A, the controller 10 displays the floating user interface that contains a plurality of menu items as shown in a screen 3210.

If a ‘rotate screen’ menu 3211, which is a terminal function menu to rotate an image being currently reproduced and display the result, is selected, the controller 10 rotates the currently displayed image by 90 degrees in the clockwise direction, displays the result, and completes the screen rotation, as in screen 3220. In this embodiment the rotation is performed by 90 degrees in the clockwise direction, but in other embodiments rotation may be performed to such an extent as determined in advance in the clockwise or counterclockwise direction.

After that, if there is a request to stop running the floating user interface or if the screen rotation has been completed, the controller 10 stops displaying the floating user interface and displays the rotated image being currently reproduced, as shown in a screen 3230.

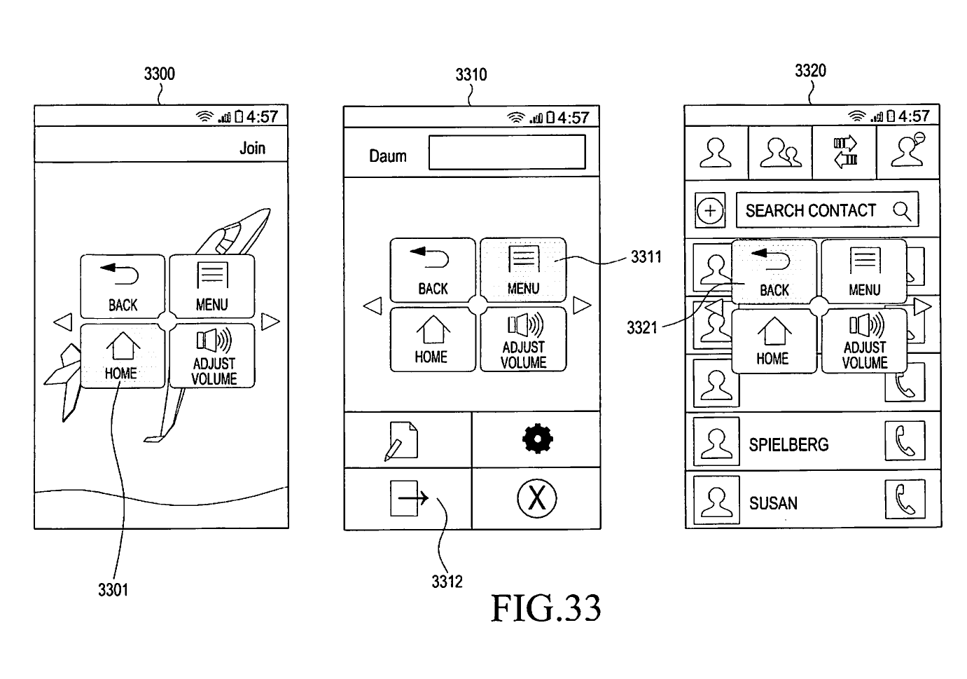

FIG. 33 illustrates a process of executing an external function menu through the floating user interface, according to an embodiment of the present invention.

The floating user interface includes a ‘home’ menu 3301, which is a terminal function menu to move to a predetermined web page as shown in a screen 3300. If the home menu is selected by the user input means while an Internet web page is being displayed, the controller 10 moves from the currently displayed web page to the predetermined web page and displays the predetermined web page.

The floating user interface includes a menu 3311, a terminal function menu to edit, set up, log out, and/or close menus as shown in a screen 3310. When the user input means enters a selection of a corresponding menu, the controller 10 displays a menu screen 3312 including edit, set up, log out, and close functions to perform the respective functions on the menu.

The floating user interface includes a ‘back’ menu 3321, which is a terminal function menu to move back to a previous menu from the currently displayed menu as shown in a screen 3320. If the user input means selects the ‘back’ menu 3321, the controller 10 moves and displays a previous screen of the currently displayed contact list.

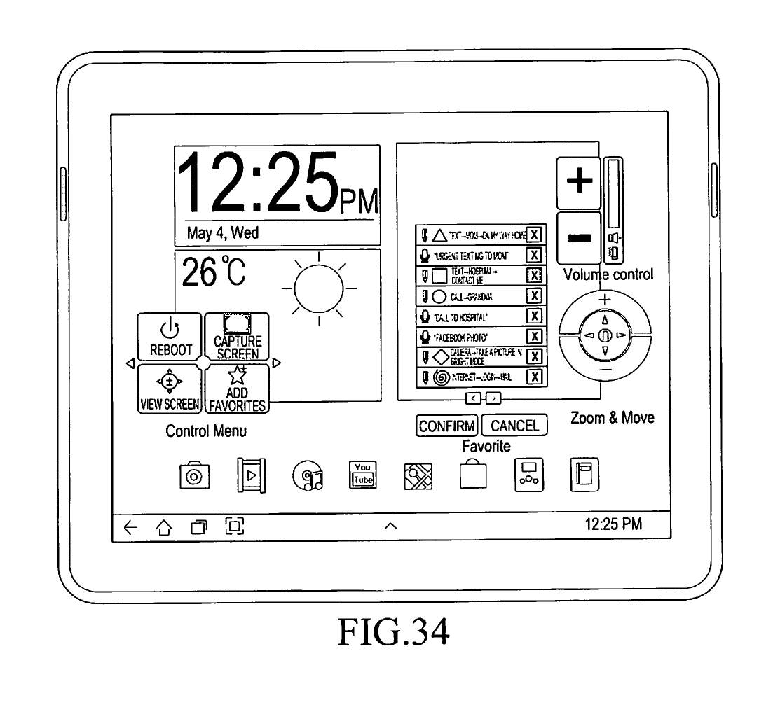

FIG. 34 illustrates a process of executing and displaying a plurality of floating user interfaces, according to an embodiment of the present invention.

In FIG. 34, the controller 10 runs a plurality of floating user interfaces in a single screen, each floating user interface displaying terminal function menus to perform terminal functions. For example, the controller 10 may display a plurality of floating user interfaces in a single screen, such as control menus to be used to control the terminal, a user action list including a plurality of user actions, an icon for moving or zooming-in/out a screen, a volume control icon, and the like.

According to the present invention, the user may conveniently perform terminal functions through the floating user interface in any environment of the terminal.

It will be appreciated that the embodiments of the present invention may be implemented in a form of hardware, software, or a combination of hardware and software. The software may be stored as program instructions or computer readable codes executable on the processor on a computer-readable medium. Examples of the computer readable recording medium include magnetic storage media (e.g., ROM, floppy disks, hard disks, etc.), and optical recording media (e.g., CD-ROMs, or DVDs). The computer readable recording medium can also be distributed over network coupled computer systems so that the computer readable code is stored and executed in a distributed fashion. This media can be read by the computer, stored in the memory, and executed by the processor. The method of providing the floating user interface may be implemented by a computer or portable terminal including a controller and a memory, and the memory may be an example of the computer readable recording medium suitable for storing a program or programs having instructions that implement the embodiments of the present invention. The present invention may be implemented by a program having codes for embodying the apparatus and method described in claims, the program being stored in a machine (or computer) readable storage medium. The program may be electronically carried on any medium, such as communication signals transferred via wired or wireless connection, and the present invention suitably includes its equivalent.

The apparatus for providing the floating user interface may receive the program from a program provider wired/wirelessly connected thereto, and store the program. The program provider may include a memory for storing programs having instructions to perform the embodiments of the present invention, information necessary for the embodiments of the present invention, etc., a communication unit for wired/wirelessly communicating with the mobile communication terminal, and a controller for sending the program to the mobile communication terminal on request or automatically.

Several embodiments have been illustrated and described, but it will be understood that various modifications can be made without departing the scope of the present invention. Thus, it will be apparent to those ordinary skilled in the art that the invention is not limited to the embodiments described, but can encompass not only the appended claims but the equivalents.

What is claimed is:

1. An apparatus for providing a floating user interface, the apparatus comprising:
a user input means;
a display unit for displaying a floating user interface including menus for terminal functions; and
a controller for displaying the floating user interface upon request by the user input means, and performing a terminal function that corresponds to a menu included in the floating user interface when there is a request to execute the menu.

2. The apparatus of claim 1, wherein the user input means includes a touch input means and a pointing input means.

3. The apparatus of claim 1, wherein the controller displays the floating user interface on a top layer of the display unit.

4. The apparatus of claim 1, wherein the controller further displays an identifier to run and display the floating user interface in the display unit.

5. The apparatus of claim 1, wherein the floating user interface includes at least one of menu item with which to configure a plurality of menus to be included in the floating user interface, menu items to set up user actions to record user inputs for performing terminal functions, and menu items for screen control.

6. The apparatus of claim 5, wherein the controller configures and displays a screen for selecting a number and types of menus to be included in the floating user interface if menu items with which to configure the menus included in the floating user interface are selected by the user input means.

7. The apparatus of claim 5, wherein the controller, upon selection of a menu item to set up a user action to record user inputs to perform the terminal functions with the user input means, displays a screen for selecting an input method to execute the user action, and upon selection of an input method with the user input means, records and then stores at least one user input entered to perform the terminal function according to the selected input method.

8. The apparatus of claim 7, wherein the input method includes one of user's voice input, gesture input, and text input.

9. The apparatus of claim 7, wherein the controller performs the terminal function according to at least one user input recorded to perform the terminal function in the selected input method.

10. The apparatus of claim 5, wherein the controller, upon selection of a menu item for the screen control with the user input means, displays a screen control icon to perform the screen control, and performs the screen control by using the displayed screen control icon.

11. The apparatus of claim 10, wherein the screen control icon includes a screen scroll control area in which to detect an input of a request to scroll a screen displayed in the display unit and a screen size control area in which to detect an input of a request to increase or reduce the screen.

12. The apparatus of claim 11, wherein the controller, upon request for scrolling of a screen displayed in the display unit, performs scrolling the screen, and wherein upon request for expansion or reduction of the screen, performs expanding or reducing the screen.

13. A method of providing a floating user interface, the method comprising:
displaying a floating user interface including menus for terminal functions if a request for displaying the floating user interface is made by a user input means; and
performing a terminal function that corresponds to a menu included in the floating user interface that is requested to be executed.

14. The method of claim 13, wherein the user input means includes a touch input means and a pointing input means.

15. The method of claim 13, wherein displaying a floating user interface comprises displaying the floating user interface on a top layer of a screen.

16. The method of claim 13, further comprising:
displaying an identifier to run and display the floating user interface in the screen.

17. The method of claim 13, wherein the floating user interface includes at least one of menu item with which to configure a plurality of menus to be included in the floating user interface, menu items to set up user actions to record user inputs for performing terminal functions, and menu items for screen control.

18. The method of claim 17, further comprising:
configuring and displaying a screen for selecting a number and types of menus to be included in the floating user interface if menu items with which to configure the menus included in the floating user interface are selected by the user input means.

19. The method of claim 17, further comprising:
upon selection of a menu item to set up a user action to record user inputs to perform the terminal functions with the user input means, displaying a screen for selecting an input method to execute the user action; and
upon selection of an input method with the user input means, recording and then storing at least one user input entered to perform the terminal function according to the selected input method.

20. The method of claim 19, wherein the input method includes one of user's voice input, gesture input, and text input.

21. The method of claim 19, further comprising:
performing the terminal function according to at least one user input recorded to perform the terminal function in the selected input method.

22. The method of claim 17, further comprising:
upon selection of a menu item for the screen control with the user input means, displaying a screen control icon to perform the screen control; and
performing the screen control by using the displayed screen control icon.

23. The method of claim 22, wherein the screen control icon includes a screen scroll control area in which to detect an input of a request for screen scroll and a screen size control area in which to detect an input of a request for screen expansion or reduction.

24. The method of claim 23, further comprising:
upon request for screen scroll, performing scrolling the screen.

25. The method of claim 23, further comprising:
upon request for expansion or reduction of the screen, performing expanding or reducing the screen.
